(19) United States
(12) Patent Application Publication
(10) Pub. No.: US 2026/0205202 A1
(43) Pub. Date: Jul. 16, 2026

(54) PARALLEL IN-MEMORY PHOTONIC COMPUTING USING CONTINUOUS-TIME DATA REPRESENTATION

(71) Applicant: Oxford University Innovation Limited, Oxford (GB)

(72) Inventors: Harish BHASKARAN, Oxford (GB); Bowei DONG, Oxford (GB); Samarth AGGARWAL, Oxford (GB)

(21) Appl. No.: 19/135,386

(22) PCT Filed: Dec. 5, 2023
(86) PCT No.: PCT/GB2023/053135

§ 371 Date: Jun. 4, 2025

(30) Foreign Application Priority Data
Dec. 7, 2022 (GB) 2218385.9

(51) Int. Cl. H04B 10/516

(52) U.S. Cl. CPC H04B 10/516

(57) ABSTRACT

Disclosed is a method of processing input data in a processor. The method comprises providing a plurality of radio frequency (RF) signals, each comprising a plurality of RF frequencies with respective component values representing input data, and providing a plurality of optical signals, each optical signal having a respective optical frequency. Each optical signal is modulated with one of the RF signals to generate modulated optical signals. Processing operations are performed on the modulated optical signals in parallel to derive a processor output. Also disclosed is a processor for processing input data according to the method.

The invention relates to methods of processing input data. In particular, performing operations using optical or photonic processors.

Machine learning (ML) models using big data provided by the surge of fifth-generation (5G) mobile network and internet of things (IoT) have revolutionized many aspects of modern technology. With this proliferation of 5G and IoT, the global data volume has grown exponentially. Global data volume reached 64.2 zettabytes in 2020 and is projected to reach 181 zettabytes in 2025.

Big data provides ML models with unprecedentedly rich information to reveal underlying data patterns for analysis and prediction. ML with big data has continued to have great social impact in many areas, including computer vision, speech recognition, natural language processing, physical sciences, computer sciences, biomedical sciences, and more.

Matrix-vector multiplication (MVM) is the basic operation that occupies around 90% of runtime in popular ML models (e.g. GoogleNet, VGG, OverFeat, AlexNet). To accelerate ML models for exponentially increasing quantities of data, significant effort has been devoted to parallelizing MVMs in hardware. Various electronic computing hardware have been employed for their parallel mode advantage. Unlike central processing units (CPUs) that only process general-purpose data serially, graphics processing units (GPUs), field-programmable gate arrays (FPGAs), and application-specific integrated circuits (ASICs) can be configured to process specific-purpose data in parallel.

One of the most notable advances in parallel electronic computing hardware is the memristive crossbar array. Various mechanisms have been explored to store memories in physical states of materials (redox, phase change, ferroelectric, magnetoresistive, etc) to enable parallel analogue in-memory computing.

A memristive crossbar array with M inputs and K outputs mathematically represents a matrix

$$W = {[ \begin{matrix}{w}_{11} {w}_{21} ⋯ {w}_{K 1} \\ {w}_{12} {w}_{22} ⋯ {w}_{K 2} \\ ⋱ \\ {w}_{1 M} {w}_{2 M} ⋯ {w}_{KM}\end{matrix} ]}^{T}$$

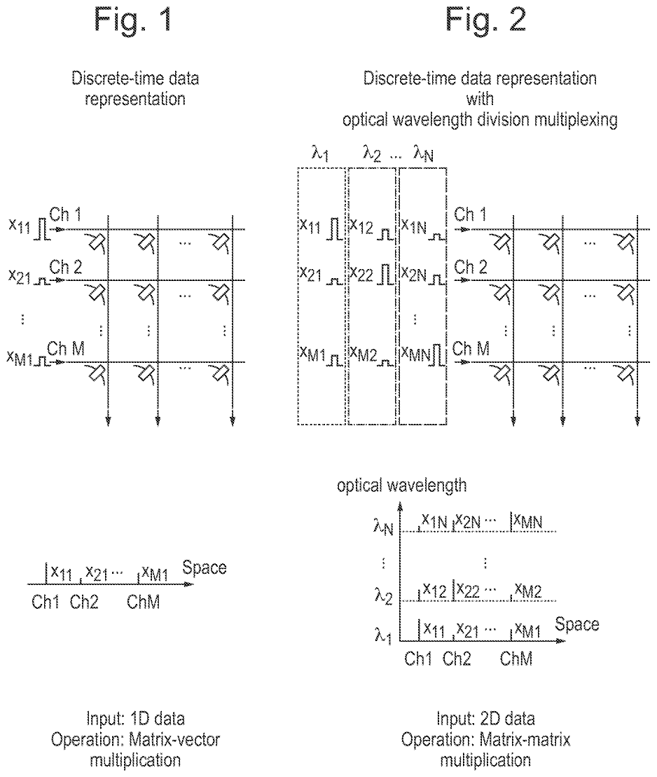

of dimension d_{K×M} that contains K d_{1×M} kernels. Each cell of the crossbar array performs a multiplication according to Ohm's law. The multiplication results are summed in output buses according to Kirchhoff's law. The input data uses the space dimension and is a one-dimensional (1D) array X_{1D}=(x₁ x₂ . . . x_{M})^{T} representing a d_{M×1} vector, leading to the ability to perform one d_{k×M}×d_{M×1} MVM in a single operation cycle. FIG. 1 shows schematically how this traditional electronic computing scheme uses the space dimension for data input, inputting a one-dimensional (1D) array to complete an MVM in a single operation cycle.

Despite the current dominance of electronics, optical MVM could potentially provide the advantages of low latency, low energy consumption, and high parallelism^{1, 2}. Compared with electronic data transmission that is inherently limited by capacitive delay and the energy consumption required to charge/discharge electronic integrated circuits, photons transmit data at the speed of light with zero power consumption. Meanwhile, optical MVM can access a huge terahertz (THz) bandwidth. This is much larger than the gigahertz (GHz) bandwidth accessible by electronics, opening the possibility of high parallelism through optical wavelength division multiplexing (OWDM).

Historically, optical MVM was implemented by light diffraction in free space^{3, 4} and continues to inspire computing architectures^{5, 6}. In the past decade, optical MVM using photonic integrated circuit (PIC) has flourished^{7, 8} owing to the development of scalable on-chip dense integration of optical waveguide components using complementary metal-oxide-semiconductor (CMOS)-compatible fabrication processes^{9, 10}. Notable progress includes the demonstration of PIC MVM processors based on cascaded Mach-Zehnder interferometer (MZI) array using coherent light as data carriers and thermo-optic phase shifters as weighting elements^{11, 12}. Broadcast-and-weight PIC MVM processors using light at different wavelengths as data carriers and tuneable microring resonator (MRR) add-drop filters as weighting elements have also been developed^{13, 14}.

More recently, optical frequency comb (OFC) technology was introduced to PIC MVM processors to provide a high-quality multi-wavelength light source with dense wavelength spacing^{15, 16}. A record high 11 TOPS has been realized using a single OFC with wavelength-and-time interleaving technique¹⁵, showing the promise of PIC MVM processors approaching cutting-edge electronic MVM processors.

In addition, it is worth noting that a photonic counterpart of the electronic crossbar array has been demonstrated¹⁶. The passive photonic crossbar array uses waveguide directional couplers (DCs) and crossings as interconnects and PCM as memories (optical transmissions tuned by non-volatile PCM crystalline state^{17, 18}).

In all PIC MVM processors (except Ref¹⁵), two degrees of freedom are used for data input, i.e. the space and optical wavelength dimension, allowing a 2D array input

$${X}_{2 D} = [ \begin{matrix}{x}_{11} {x}_{12} ⋯ {x}_{1 Q} \\ {x}_{21} {x}_{22} ⋯ {x}_{2 Q} \\ ⋱ \\ {x}_{M 1} {x}_{M 2} ⋯ {x}_{MQ}\end{matrix} ]$$

representing a d_{M×Q} matrix. This is illustrated schematically in FIG. 2, which shows how this recent photonic computing scheme uses the space dimension and the optical wavelength dimension. Q d_{M×1} input vectors, each carried by a different wavelength λ_{q}, q∈[1, Q]⊆Z⁺, can be processed in parallel, leading to one d_{k×M}×d_{M×Q} matrix-matrix multiplication (MMM, equivalent to Q d_{k×M}×d_{M×1} MVMs) in an operation cycle.

The latest advance of delocalized photonic MVM processors on the internet's edge is also in principle using only two degrees of freedom for data input, i.e. space and optical wavelength dimension¹⁹. A similar endeavour to enhance parallelism was recently reported in electronic crossbar arrays by exploring continuous-time data representation²⁰. Conceptually similar to OWDM, continuous-time data is generated by multiplexing RF signals at different frequencies. Data is encoded in the amplitude of each RF component. Therefore, the space and RF dimensions are used simultaneously to enrich input information. However, the input data is still a 2D array that only leads to one d_{k×M}×d_{M×N} MMM (equivalent to N d_{k×M}×d_{M×1} MVMs) if N RF components are used.

Parallelism enhancement factors (PEF, defined as the number of MVMs in an operation cycle of a physical device) of 4 using a photonic crossbar array¹⁶ and 16 using an electronic crossbar array with continuous-time data representation²⁰ have been realized. Although these advances go some way to helping to speed up these demanding, highly parallel operations, there is still a need to find faster ways of performing parallel processing of matrix operations. This will have advantages particularly in applications such as machine learning, as described above.

According to a first aspect, there is provided a method of processing input data in a processor, the method comprising: providing a plurality of radio frequency, RF, signals, each RF signal comprising a plurality of RF frequencies with respective component values representing input data; providing a plurality of optical signals, each optical signal having a respective optical frequency; modulating each optical signal with a respective RF signal of the plurality of RF signals to generate modulated optical signals; and performing processing operations on the modulated optical signals in parallel to derive a processor output.

This novel computing architecture is capable of naturally implementing parallel MMMs by exploiting three degrees of freedom for data input. The method introduces a new radio frequency (RF) dimension in addition to the space and optical wavelength dimensions previously used in photonic crossbar arrays by using continuous-time data representation. An ultra-high PEF of 100 is achieved, two orders of magnitude higher than previous photonic crossbar array systems that use only two degrees of freedom. The method is applicable to any photonic processing system to enrich data information by exploiting more degrees of freedom, with particular advantage for convolutional processing.

In some embodiments, the optical frequencies of the plurality of optical signals are separated from each other by at least two times a highest of the plurality of RF frequencies, optionally at least 10 GHz. This ensures that the modulations of optical signals adjacent to one another in frequency are sufficiently separated to clearly distinguish all of the encoded data.

In some embodiments, providing the plurality of optical signals comprises demultiplexing a combined optical signal comprising a plurality of optical frequencies into individual optical signals, each individual optical signal having a respective one of the plurality of optical frequencies of the combined optical signal. This allows the combined optical signal to be generated and transmitted to the processor as a single signal, rather than generating and transmitting the plurality of optical signals separately, thereby simplifying the associated transmission system. The combined optical signal may be provided by a broadband light source, for example a frequency comb, supercontinuum laser, or LED bank.

In some embodiments, providing the RF signals comprises generating an initial RF signal comprising each of the plurality of RF frequencies, and modulating each RF frequency of the initial RF signal with input data to generate the plurality of RF signals. This simplifies the signal generation process by allowing a single initial RF signal to be generated that can then be divided to generate the plurality of RF signals. This can also improve the consistency of the RF signal generation because all of the RF signals originate from the same source. It also allows the input data to be provided in a traditional format, rather than requiring inputs in the form of RF signals.

In some embodiments, the method further comprises multiplexing subsets of the modulated optical signals into multiplexed optical signals before performing the processing operation, and performing the processing operation on the multiplexed optical signals. This allows the multiplexed optical signals to be transmitted through a single channel to be combined appropriately for processing.

In some embodiments, the processing operation is performed with a processing operation unit having a plurality of outputs, and the method further comprises: selectively demultiplexing each output of the processing operation unit based on predetermined subsets of optical frequencies and detecting the resulting demultiplexed signals to derive the processor output. This allows particular results of the parallel operations to be separated for later use or further processing.

In some embodiments, the processing operation is or comprises a matrix-vector multiplication and/or a matrix-matrix multiplication. In such embodiments, the respective component values of the RF frequencies of the plurality of RF signals may represent elements of a plurality of input matrices. These types of operation are particularly suited for and benefit from the highly parallel processing enabled by the present method.

In some embodiments, performing the processing operation comprises inputting the modulated optical signals into an array of photonic memory elements, each photonic memory element configured to store a value of an element of a data matrix. These memory elements allow temporary non-volatile storage of values to enable processing operations.

According to a second aspect, there is provided a processor for processing input data, the processor comprising: an RF signal generator configured to generate a plurality of RF signals, each RF signal comprising a plurality of RF frequencies with respective component values representing input data; an optical signal generator configured to generate a plurality of optical signals, each optical signal having a respective optical frequency; a modulator configured to modulate each optical signal with a respective RF signal of the plurality of RF signals to generate modulated optical signals; and a processing operation unit configured to perform a processing operation on each modulated signal in parallel to derive a processor output.

The processor implements the novel computing architecture described above. This novel architecture is capable of naturally implementing parallel MMMs by exploiting three degrees of freedom for data input. A new radio frequency (RF) dimension is introduced in addition to the space and optical wavelength dimensions previously used in photonic crossbar arrays by using continuous-time data representation. An ultra-high PEF of 100 can be achieved, two orders of magnitude higher than previous photonic crossbar array systems that use only two degrees of freedom. The processor can be used in any photonic processing system to enrich data information by exploiting more degrees of freedom, with particular advantage for convolutional processing.

In some embodiments, the optical signal generator is configured to generate optical signals with frequencies separated from each other by at least two times a highest of the plurality of RF frequencies, optionally at least 10 GHz. This ensures that the modulations of optical signals adjacent to one another in frequency are sufficiently separated to clearly distinguish all of the encoded data.

In some embodiments, the optical signal generator comprises a broadband light source, for example a frequency comb, supercontinuum laser, or LED bank. These types of light source are particularly suited to generating the plural optical signals necessary for the processor to operate.

In some embodiments, the modulator comprises an electro-optic modulator array. These modulators are able to effectively mix optical and RF signals to ensure the modulated optical signals are generated reliably and consistently.

In some embodiments, the processing operation unit is configured to perform matrix vector multiplications and/or matrix-matrix multiplications, such that the processor output represents the results of a plurality of matrix vector multiplications and/or matrix-matrix multiplications performed in parallel. These types of operation are particularly suited for and benefit from the highly parallel processing enabled by the processor.

In some embodiments, the processing operation unit comprises an optical waveguide crossbar array having a plurality of input lines and a plurality of output lines, wherein the modulator is configured to provide the modulated optical signals to the input lines of the optical waveguide crossbar array. This layout allows the processor to be efficiently addressed, and for the results of operations such as matrix-vector or matrix-matrix operations to be easily extracted from the processor.

In some embodiments, the processing operation unit comprises an array of photonic memory elements. These memory elements allow temporary non-volatile storage of values to enable certain processing operations. Optionally the photonic memory elements comprise phase-change material.

In some embodiments, the photonic memory elements are arranged at crossing points of the optical waveguide crossbar array; and a respective output signal of each output line represents a dot-product between values stored in the photonic memory elements of a respective column of the optical waveguide crossbar array and the modulated optical signals. This operation is particularly important when performing MVMs or MMMs.

In some embodiments, the processing operation unit further comprises tuneable power splitters and/or directional couplers arranged at the crossing points of the optical waveguide crossbar array. These additional elements enable other types of arithmetic operations at the crossing points, such as addition.

In some embodiments, the processor further comprises one or more photodetectors configured to detect an output of the processing operation unit to derive the processor output. These components are readily available and particularly suited to extracting the optical signal information from the output of the processing operation unit.

In some embodiments, the processor further comprises an electronic control element, for example an application-specific integrated circuit or a field programmable gate array, configured to control the RF signal generator to generate the RF signals and/or to receive the processor output from the processing operation unit. This allows the processor to efficiently and consistently control its own operation and be provided as an integrated component for installation in a photonic computing system.

In some embodiments, the processor is a co-processor. This allows the processor to be installed in a computing system to handle the specific types of operation for which its parallelised computing is most efficient. This relieves other components of the computing system from the loads of those operations, improving the overall efficiency of the computing system.

Embodiments of the invention will now be described, by way of example only, with reference to the accompanying drawings in which corresponding reference symbols represent corresponding parts, and in which:

FIG. 1 shows how a traditional electronic computing scheme uses the space dimension for data input;

FIG. 2 shows how photonic computing uses the space dimension and the optical wavelength dimension for data input;

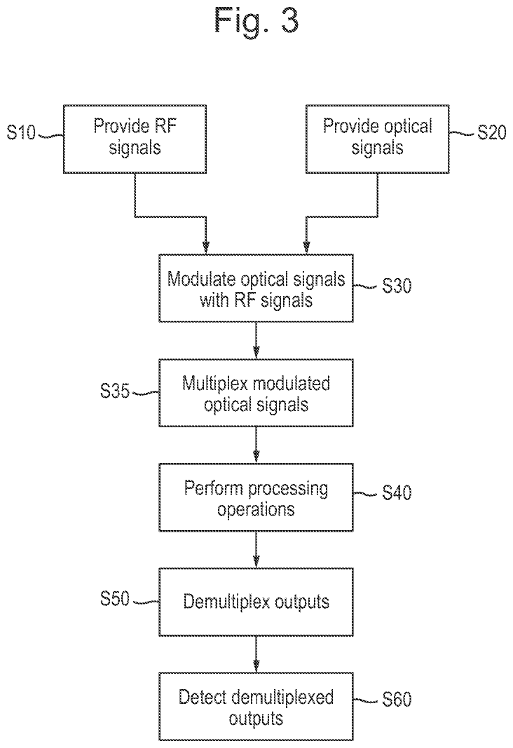

FIG. 3 is a flowchart of the present method;

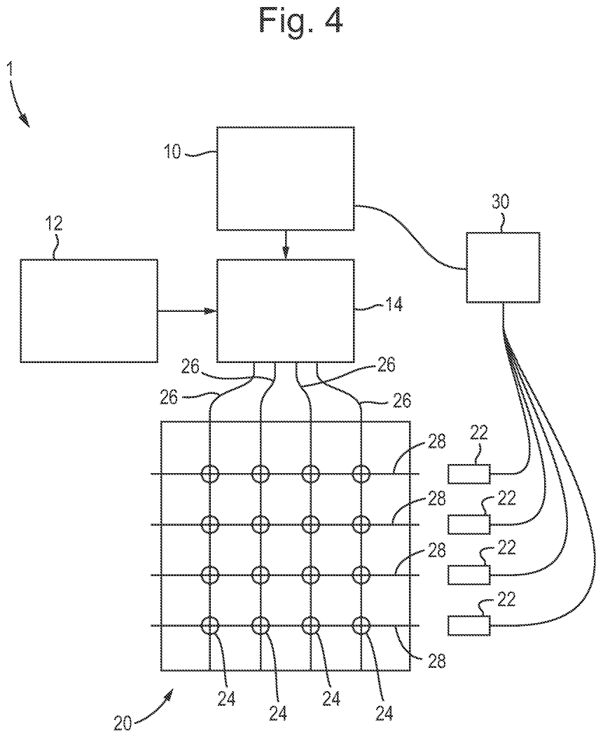

FIG. 4 is a schematic of a processor implementing the present method;

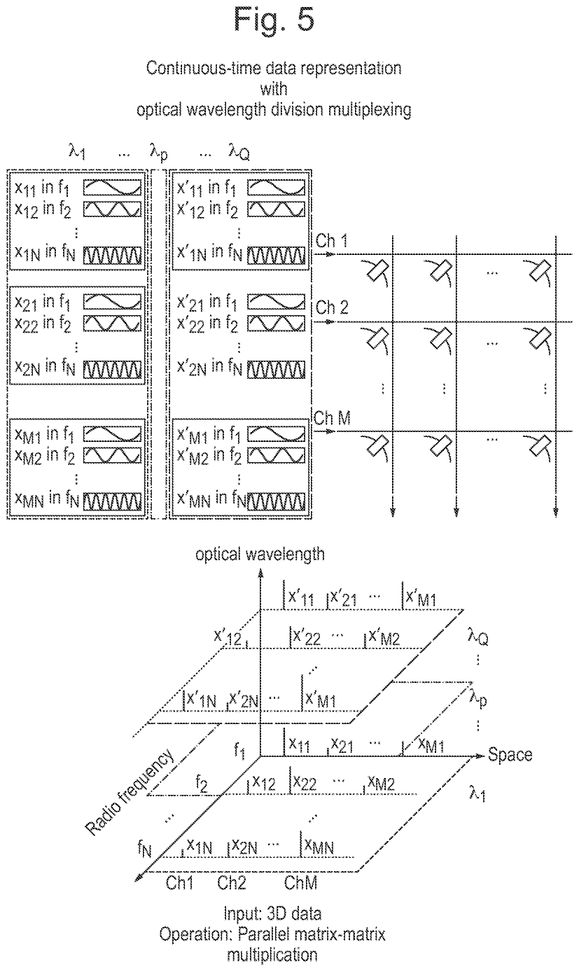

FIG. 5 shows how the present method uses space, optical, and RF dimensions for data input;

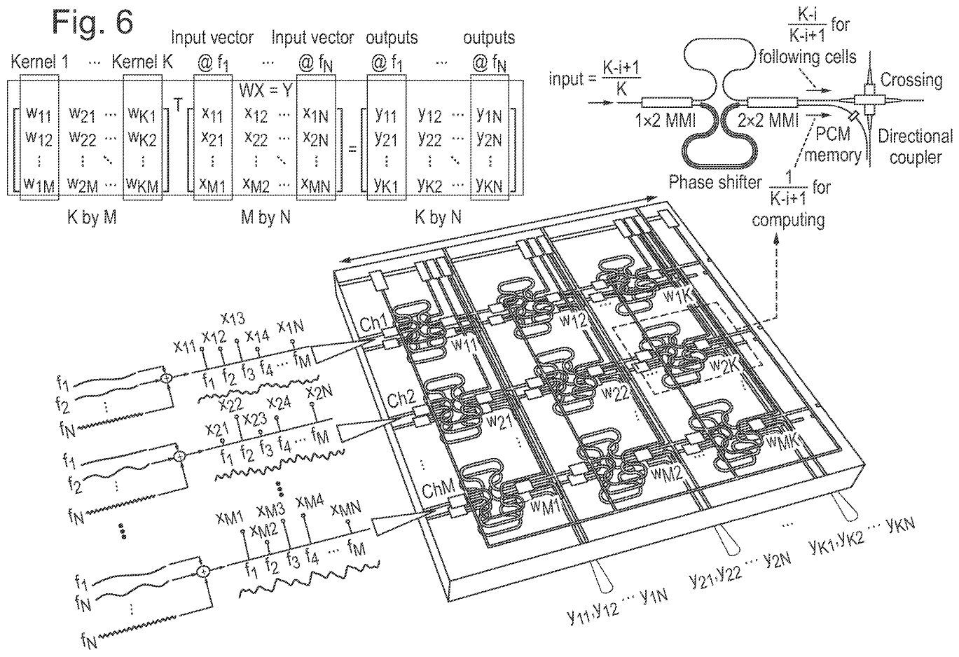

FIG. 6 illustrates data input to the processor of FIG. 4;

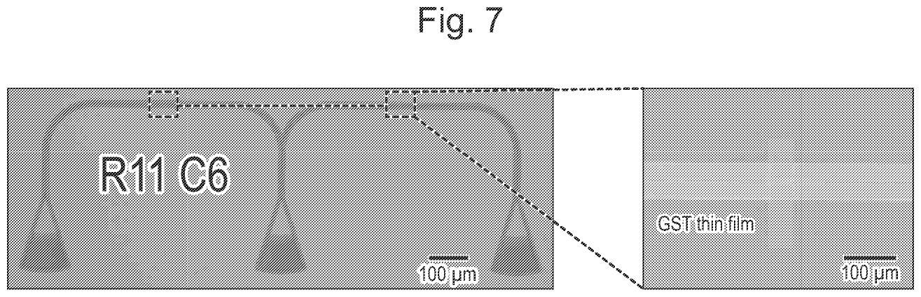

FIG. 7 shows a waveguide that forms part of the photonic crossbar array;

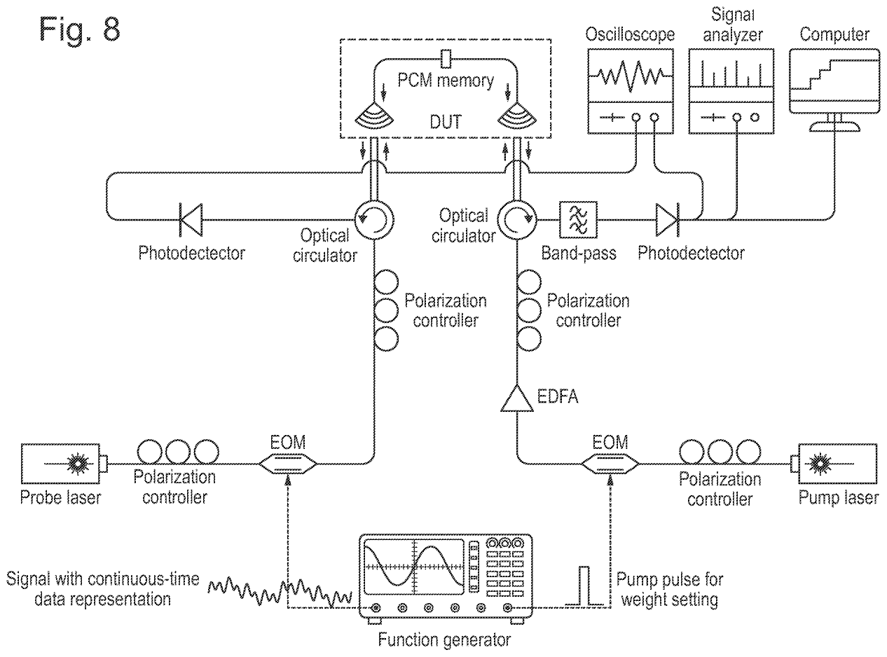

FIG. 8 shows the experimental setup used to verify transmission and multiplication operations;

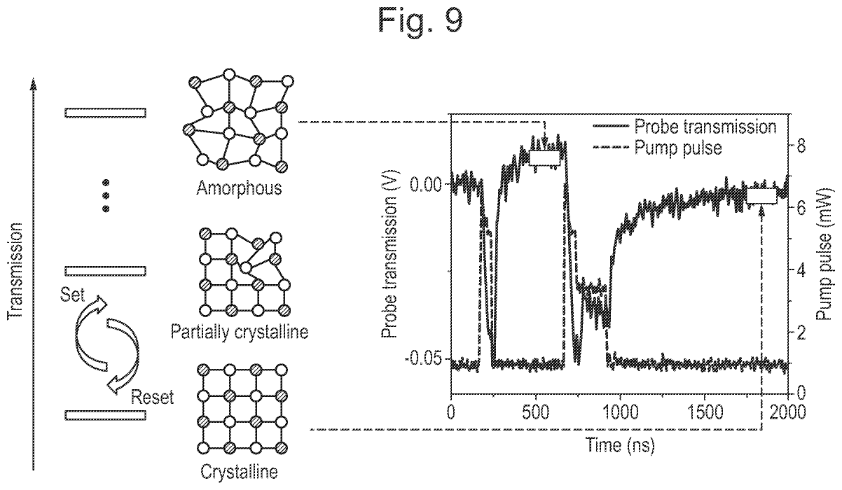

FIG. 9 illustrates the change in transmission when setting PCM memory elements;

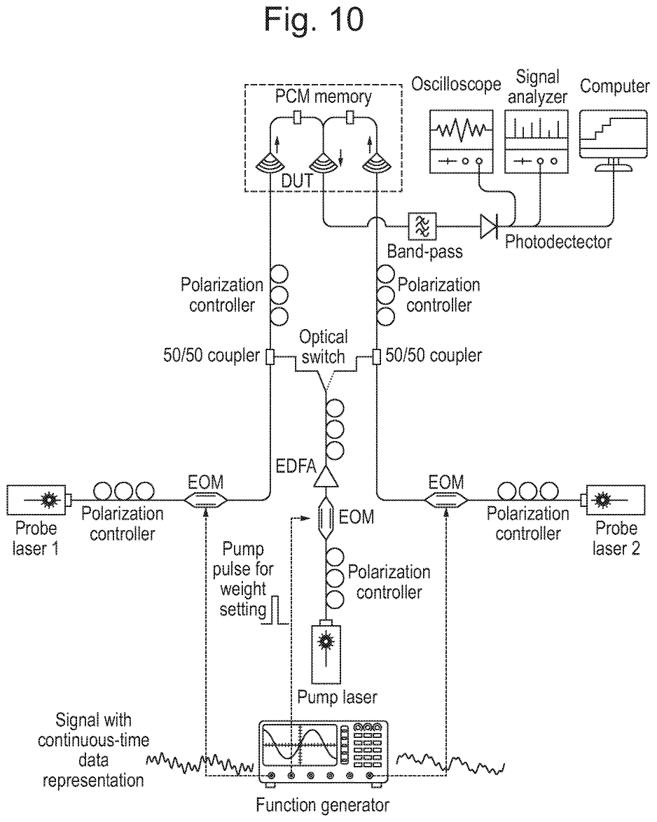

FIG. 10 shows the experimental setup used to verify addition and multiply-accumulate operations;

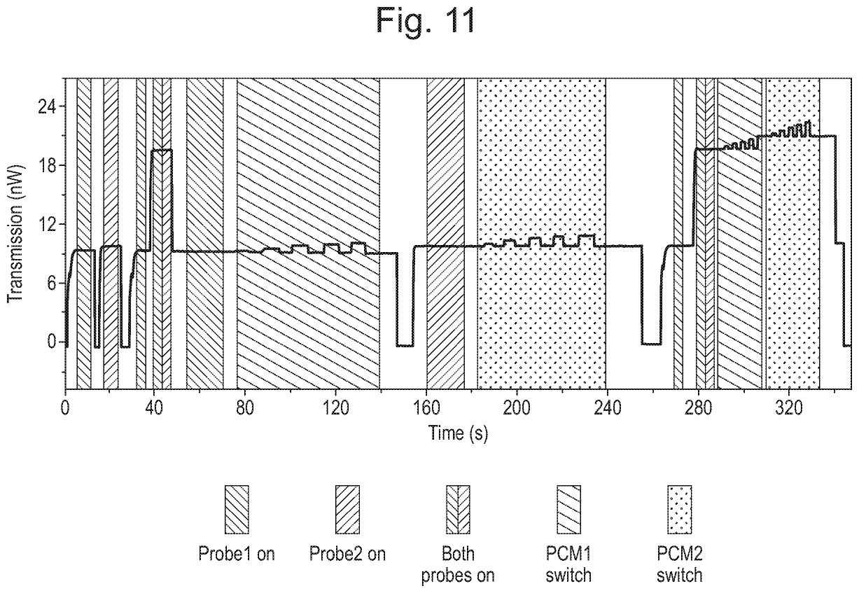

FIG. 11 shows the output of PCM memory switching;

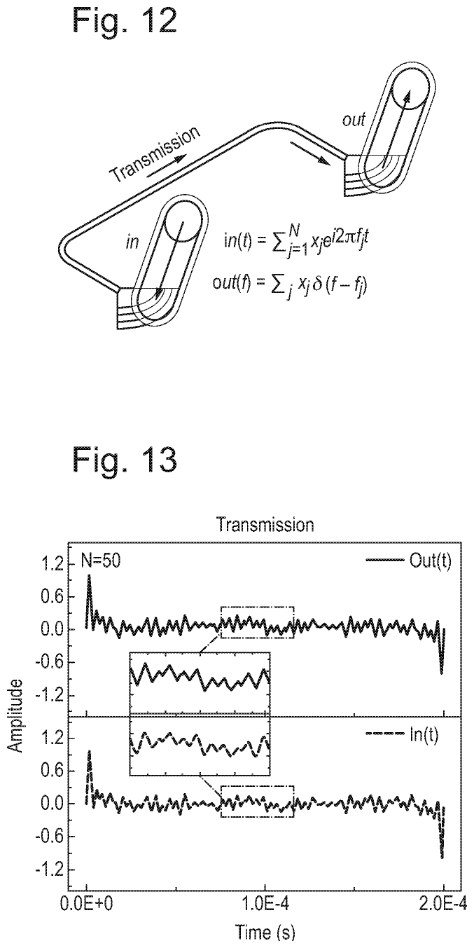

FIG. 12 shows the waveguide used to verify transmission operations;

FIG. 13 shows transmission output in the time domain;

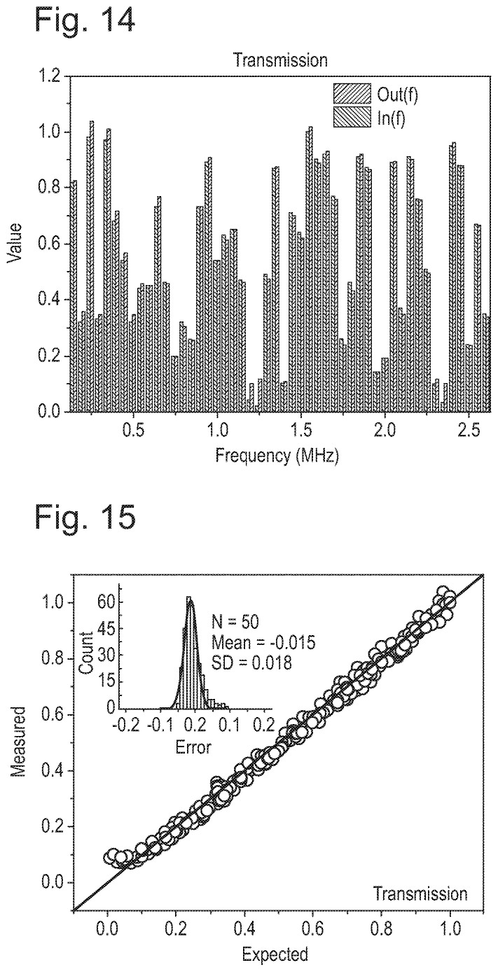

FIG. 14 shows transmission output in the frequency domain;

FIG. 15 shows errors in transmission results;

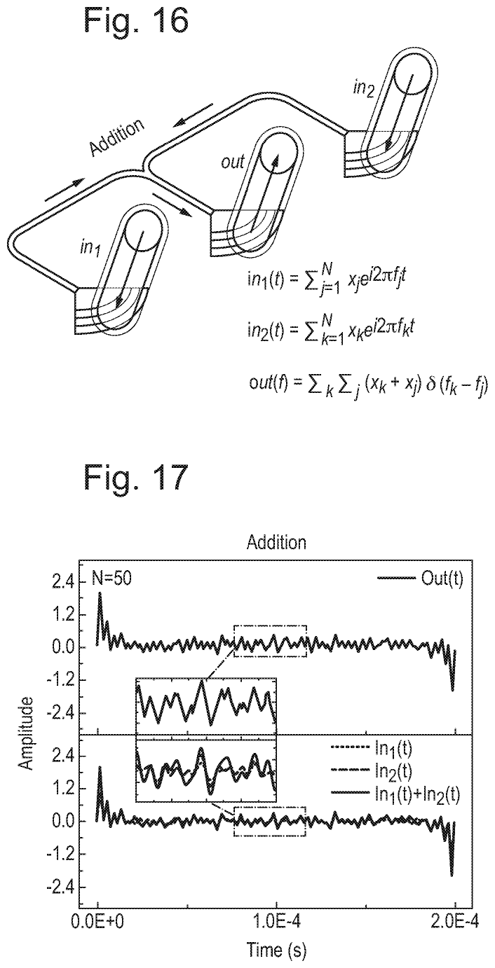

FIG. 16 shows the waveguide used to verify addition operations;

FIG. 17 shows addition output in the time domain;

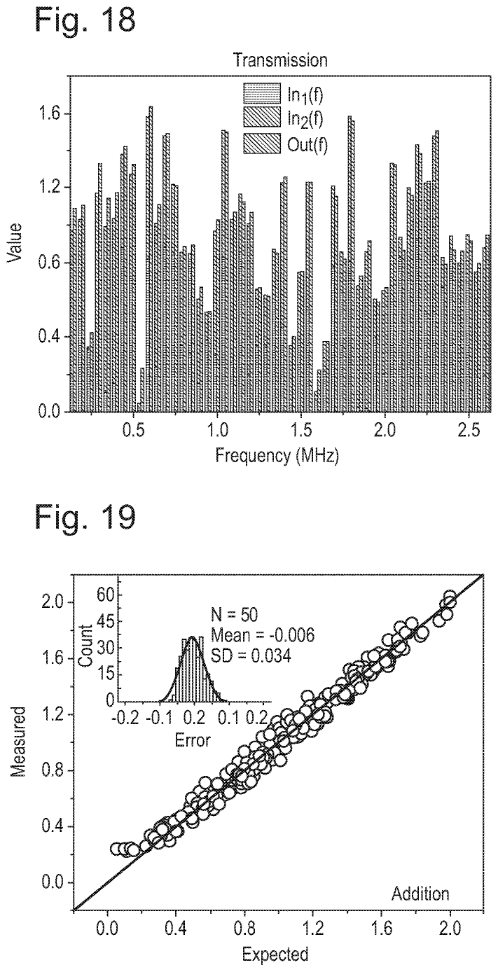

FIG. 18 shows addition output in the frequency domain;

FIG. 19 shows errors in addition results;

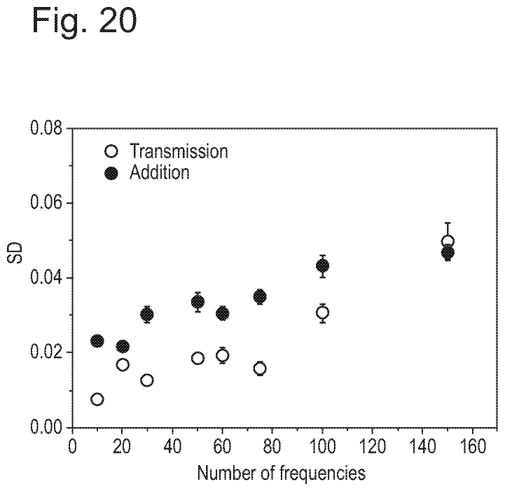

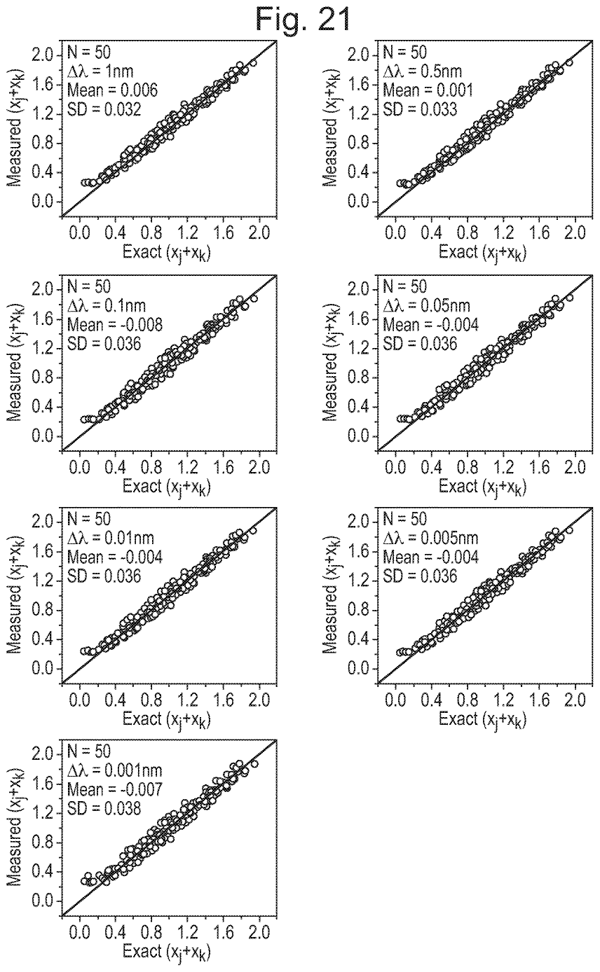

FIG. 20 shows the change in error for transmission and addition operations as the number of RF frequencies is changed;

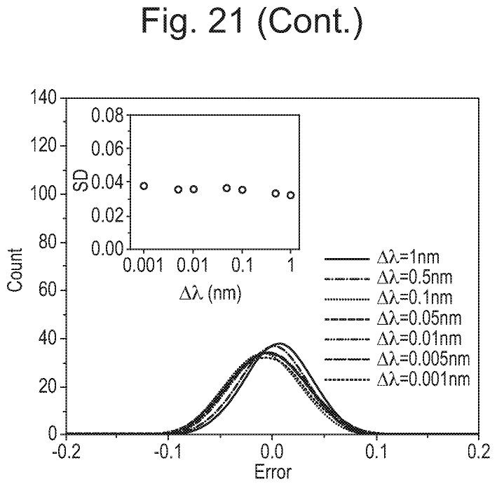

FIG. 21 shows accuracy of addition operation with varying optical wavelength spacing;

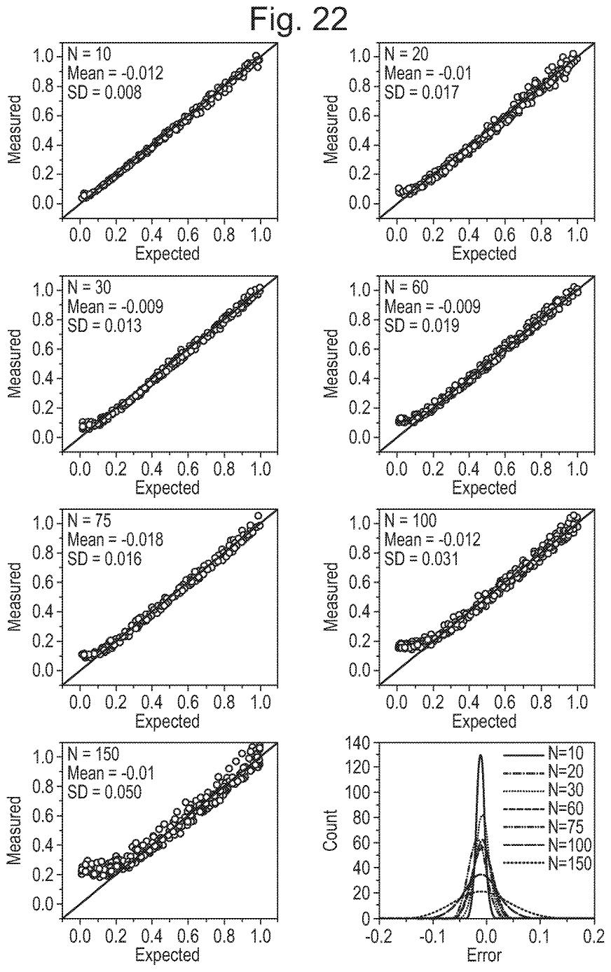

FIG. 22 shows accuracy of transmission operations when using different numbers of multiplexed RF frequencies;

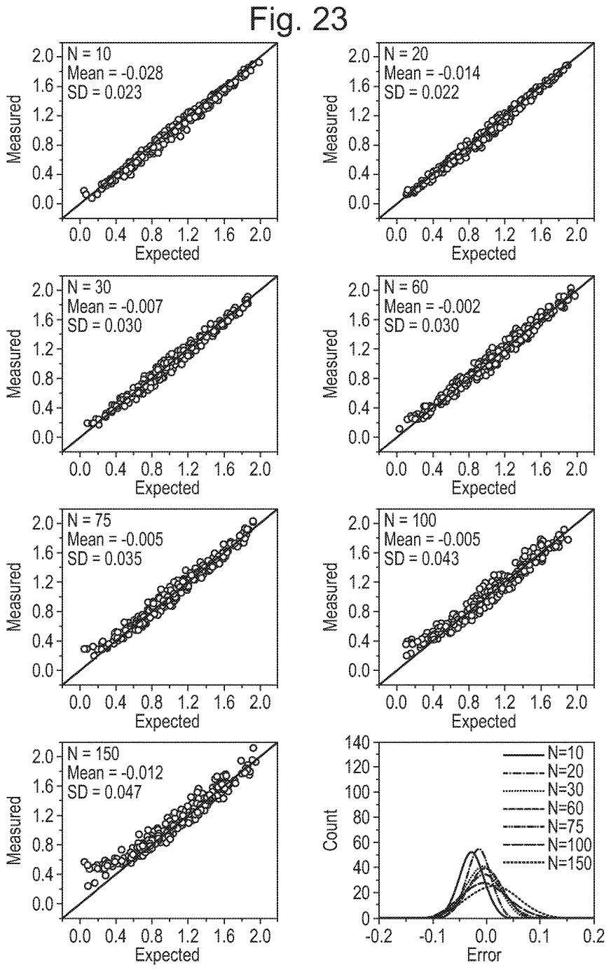

FIG. 23 shows accuracy of addition operations when using different numbers of multiplexed RF frequencies;

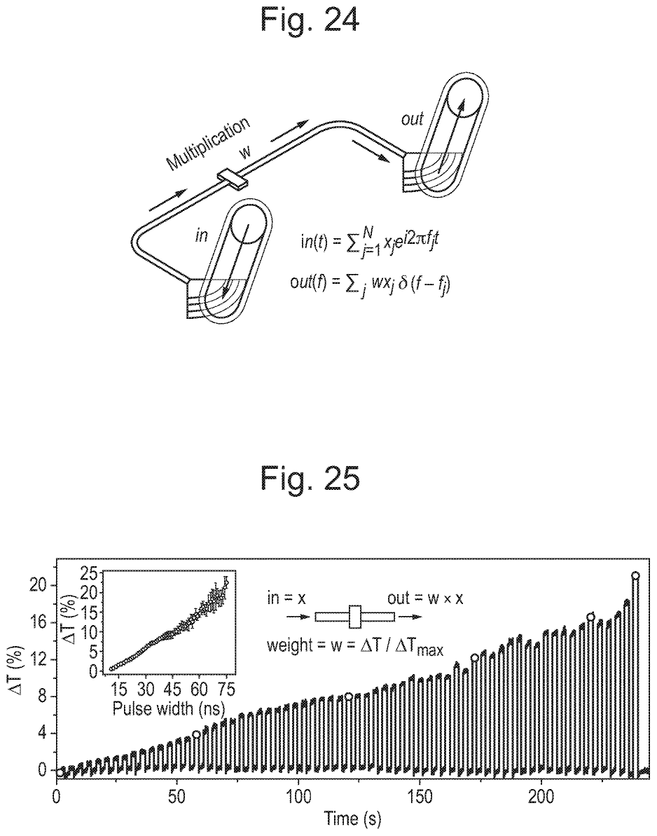

FIG. 24 shows the waveguide used to verify multiplication operations;

FIG. 25 shows change in optical transmission of the photonic memory elements with changing amorphization pulse width;

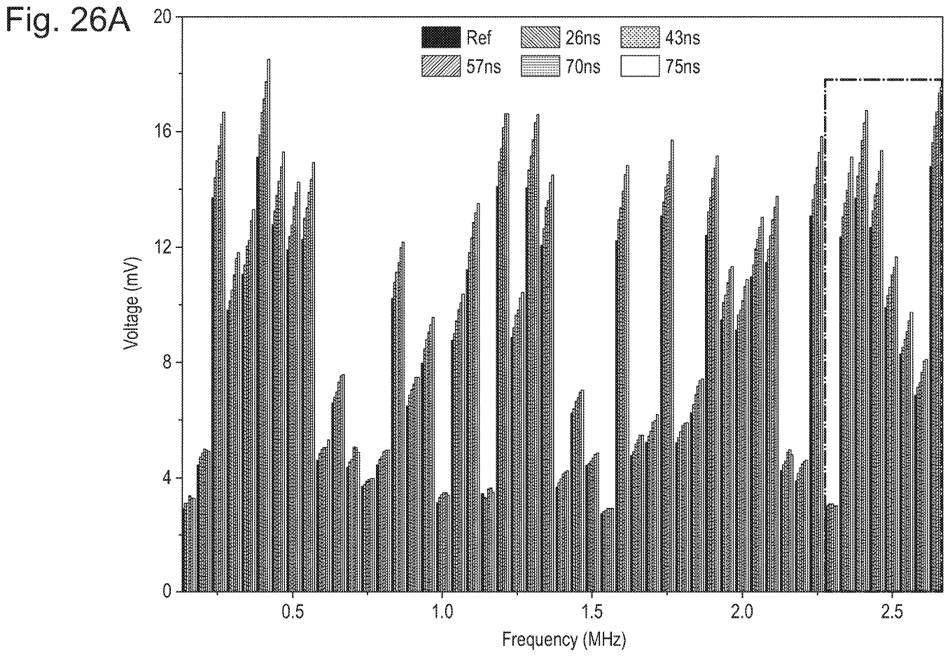

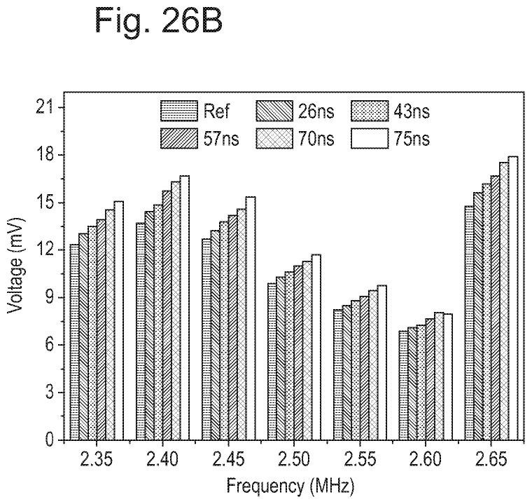

FIG. 26 shows frequency-domain output results of multiplication at different memory element settings;

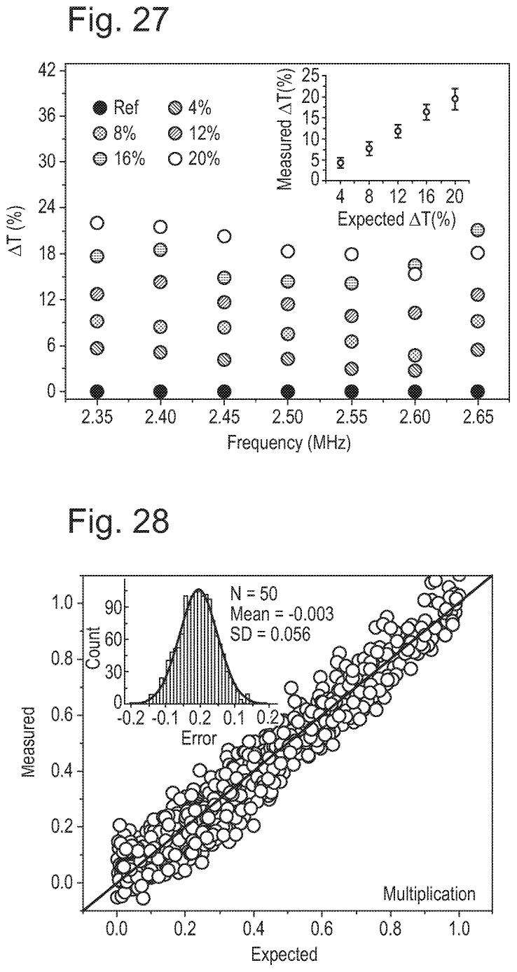

FIG. 27 shows quantitative results of transmission differences in the results of FIG. 26;

FIG. 28 shows errors in multiplication results;

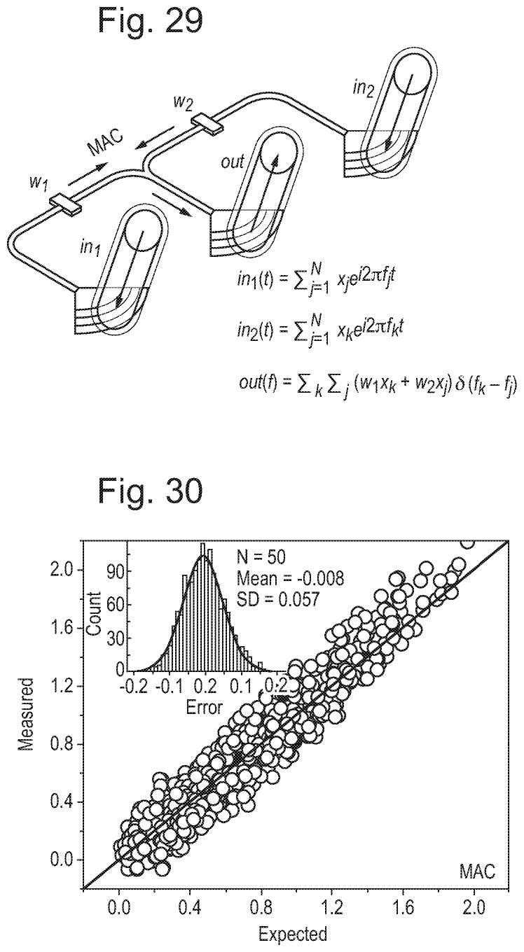

FIG. 29 shows the waveguide used to verify multiply-accumulate operations;

FIG. 30 shows errors in multiply-accumulate results;

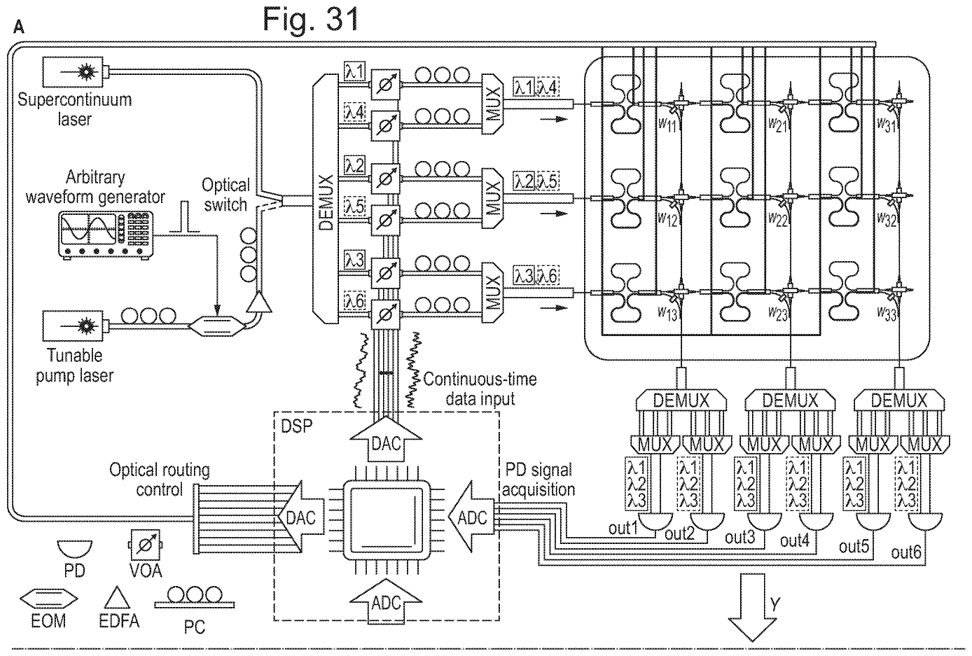

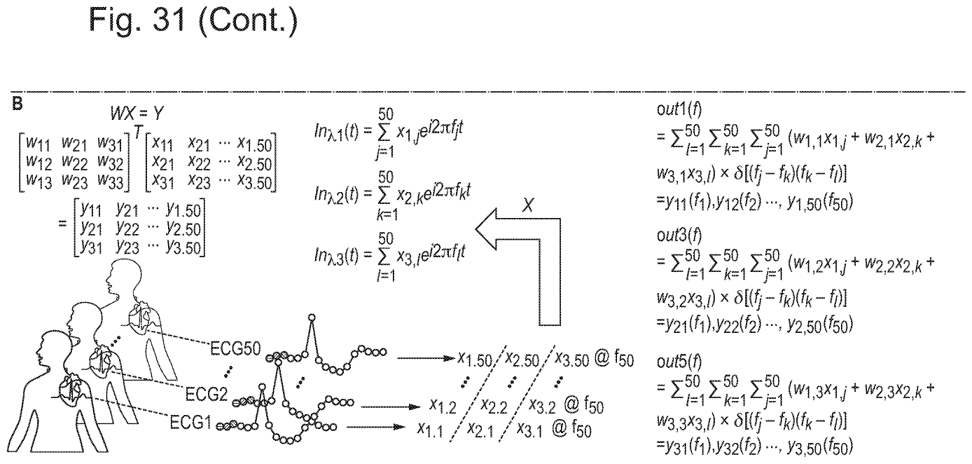

FIG. 31 is a schematic of the setup used to convolve ECG measurements;

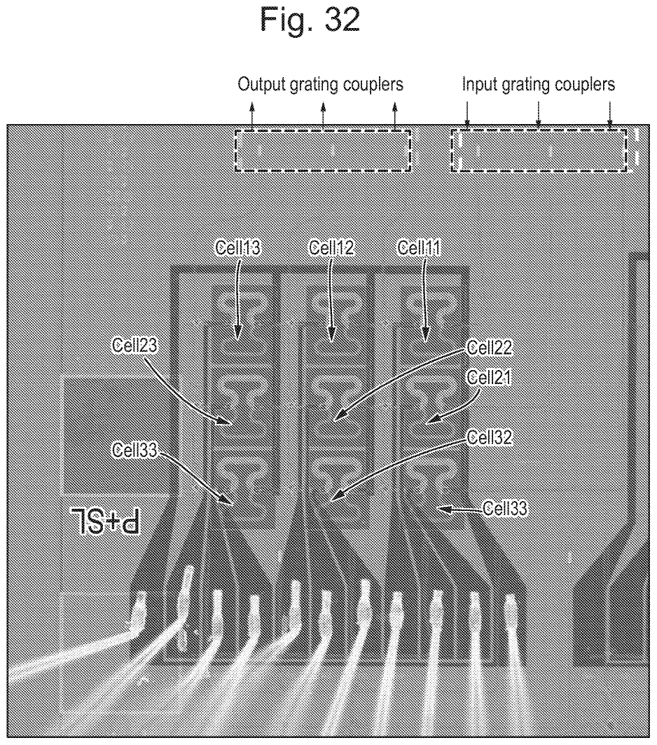

FIG. 32 shows the processor device used for convolving ECG measurements;

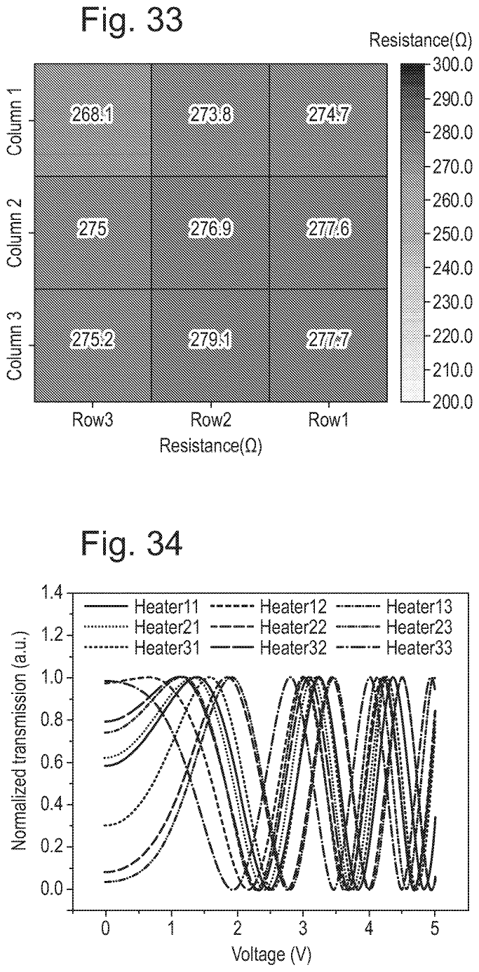

FIG. 33 shows the electrical response of the photonic crossbar array of FIG. 32;

FIG. 34 shows the optical response of the photonic crossbar array of FIG. 32;

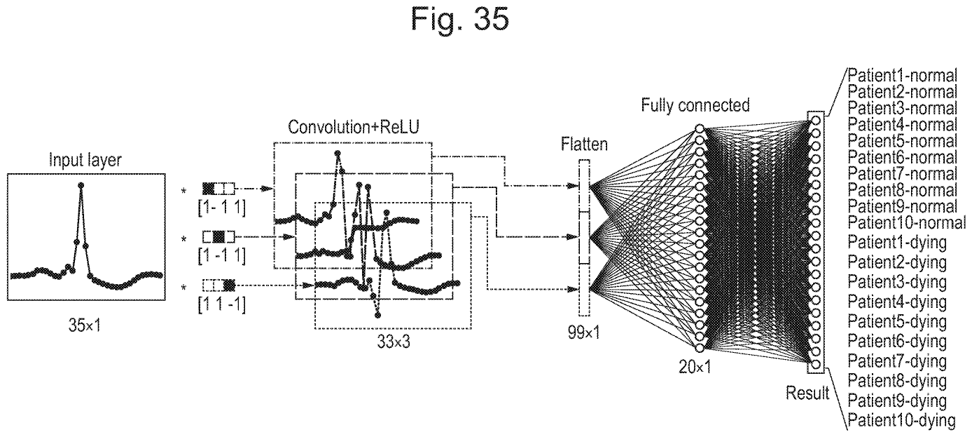

FIG. 35 shows the architecture of the convolutional neural network used for cardiovascular disease diagnosis;

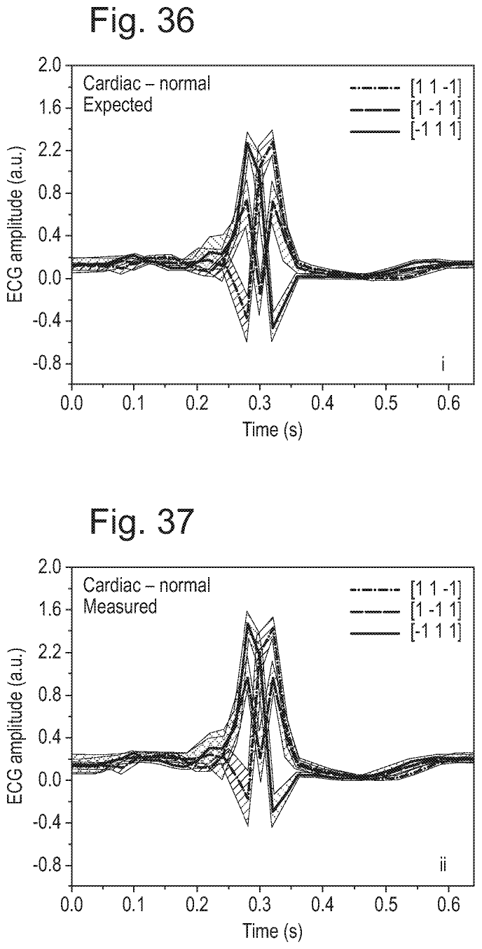

FIG. 36 shows expected convolution results of normal ECG signals;

FIG. 37 shows measured convolution results of normal ECG signals;

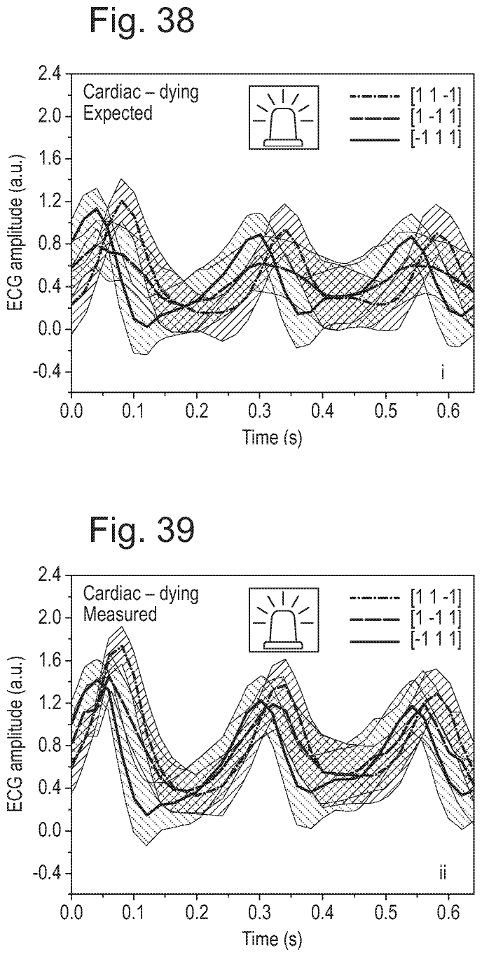

FIG. 38 shows expected convolution results in sudden death events;

FIG. 39 shows measured convolution results in sudden death events;

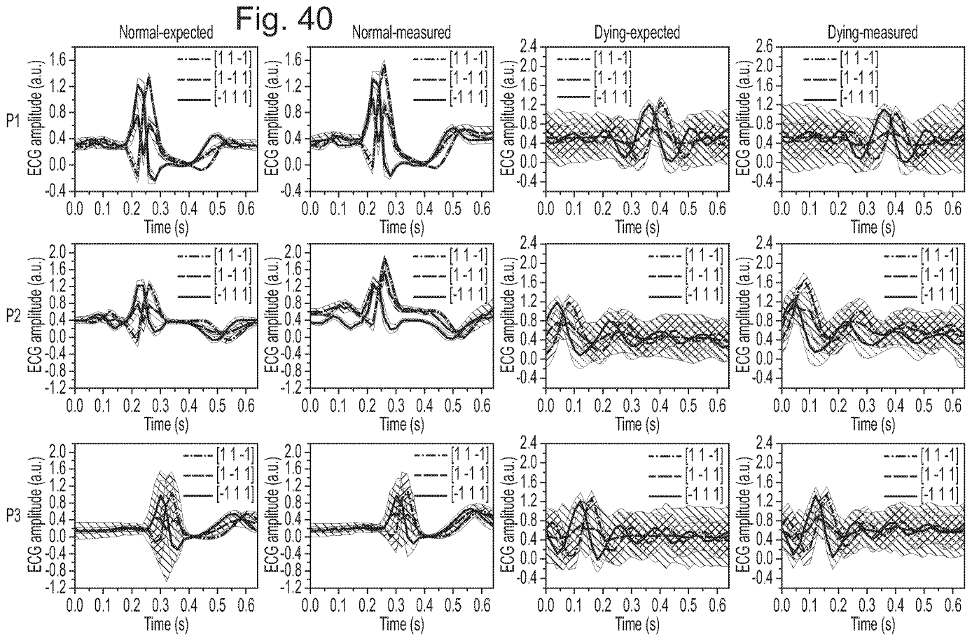

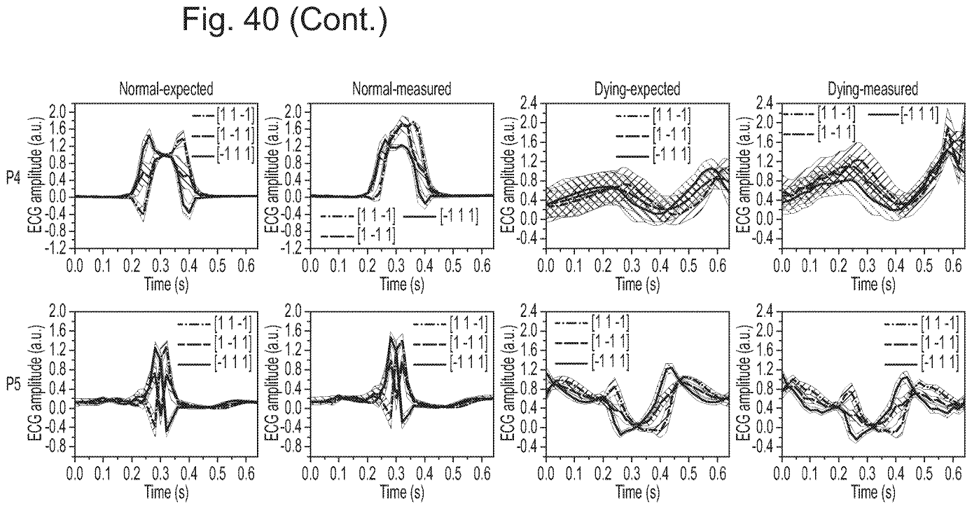

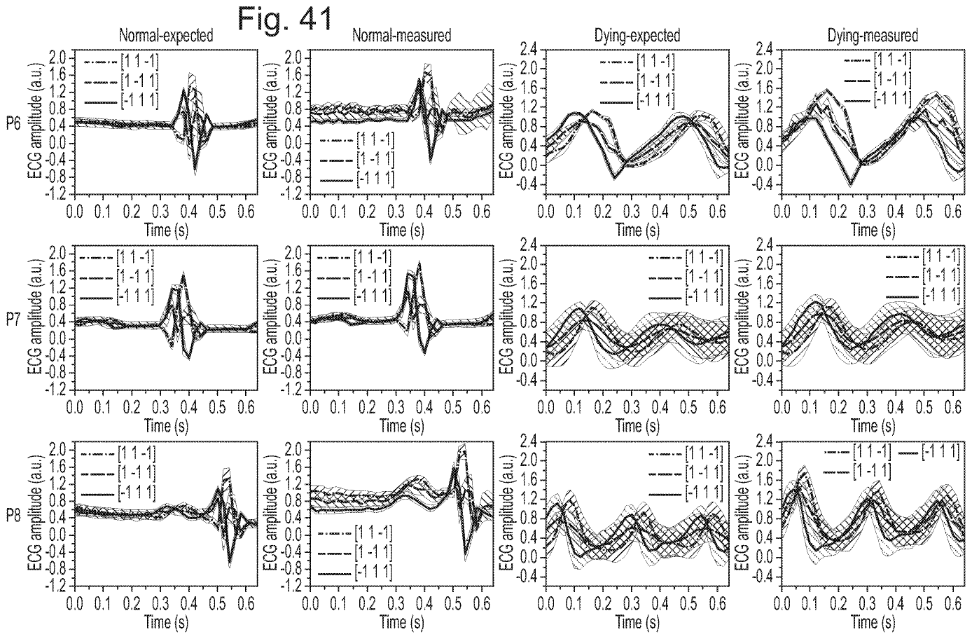

FIG. 40 shows expected and measured convolution results of normal ECG signals and in sudden death events for five patients;

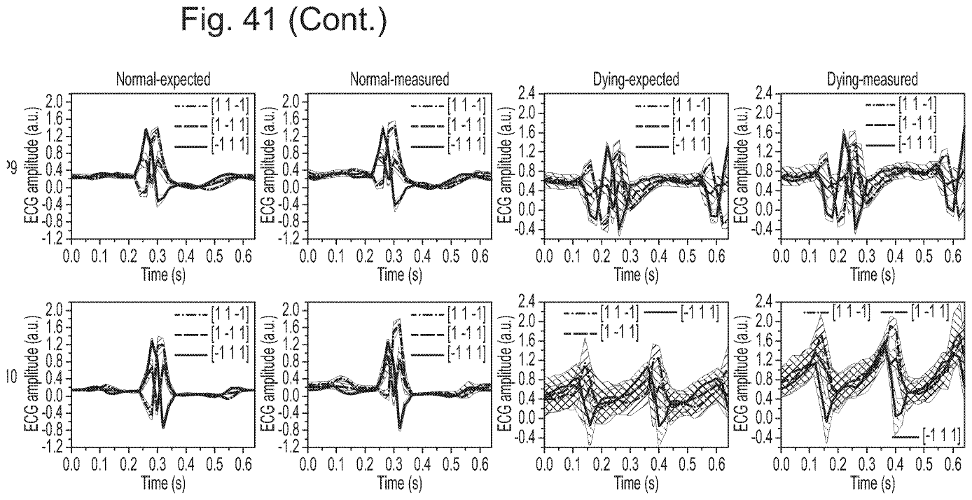

FIG. 41 shows expected and measured convolution results of normal ECG signals and in sudden death events for a further five patients;

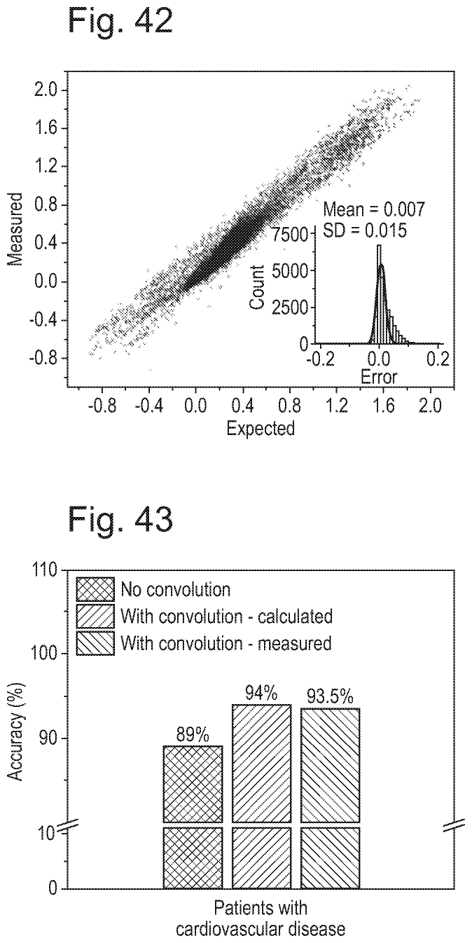

FIG. 42 shows convolution accuracy of ECG data;

FIG. 43 shows CNN classification accuracies based on ECG data;

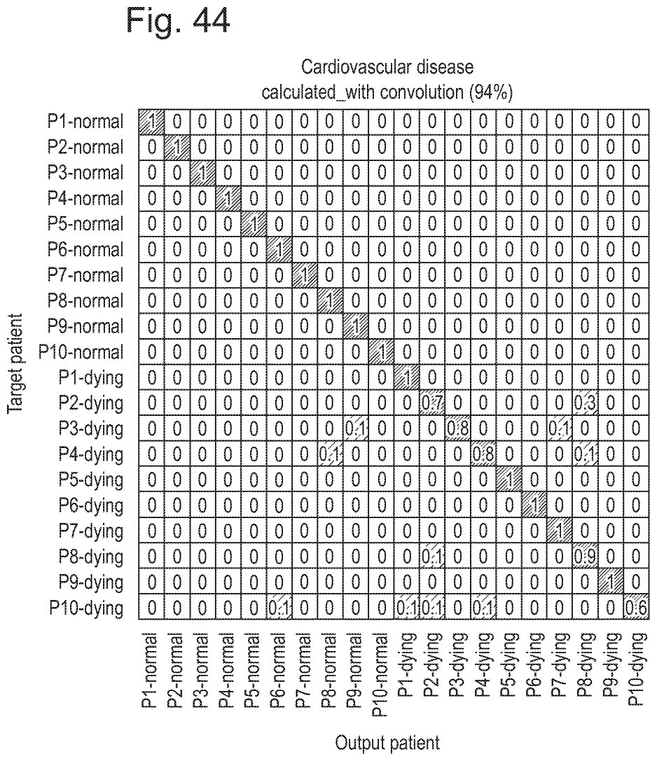

FIG. 44 shows confusion maps of CNN classification results using CPU-convolved results;

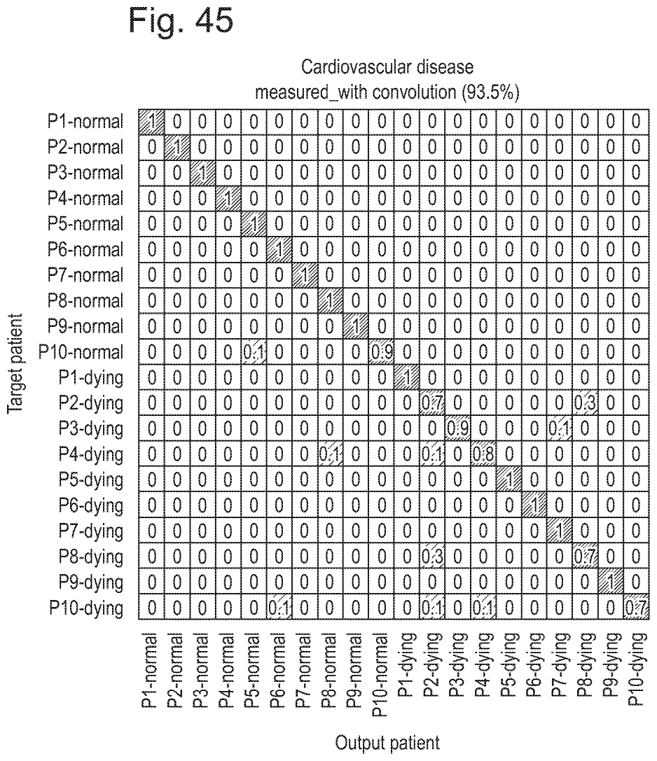

FIG. 45 shows confusion maps of CNN classification results using system-convolved results;

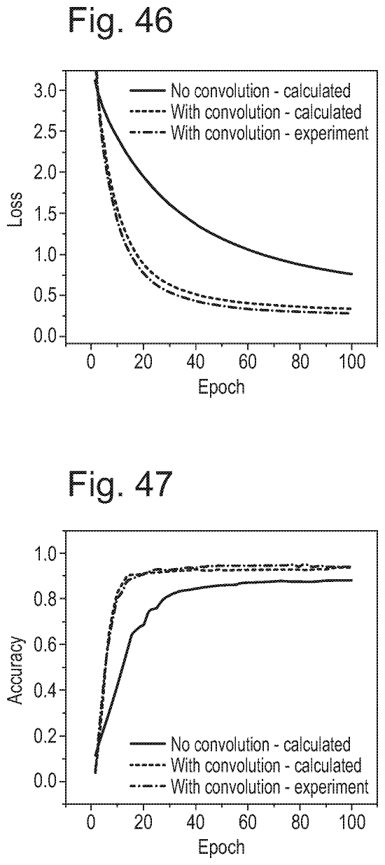

FIG. 46 shows loss evolution curves with increasing epoch for CPU-convolved and system-convolved results; and

FIG. 47 shows accuracy evolution curves with increasing epoch for CPU-convolved and system-convolved results.

The present invention provides a method of processing input data in a processor. A flowchart of the method is shown in FIG. 3. The present invention also provides a processor for processing input data, which can carry out the method. A schematic of the processor 1 is shown in FIG. 4. The processor 1 may be a co-processor, for example to perform certain types of operations (such as MVMs or MMMs) more efficiently than would be possible on a general-purpose central processing unit (CPU).

The method and processor provide a computing architecture that allows 3D array inputs for ultra-parallel MVM by simultaneously exploiting three degrees of freedom, i.e. space dimension, optical wavelength dimension, and RF dimension. The computing architecture utilizes continuous-time data representation instead of traditional discrete-time data representation to add the RF dimension as the third dimension for data input. Moving from 1D to 2D to 3D data representation by introducing more degrees of freedom, the system PEF is increased from 1 to (Q or N) to Q×N (where Q is the number of optical wavelengths used and N the number of RF wavelengths), providing a viable path for ultra-parallel photonic computing.

The method comprises providing S10 a plurality of radio frequency (RF) signals. Although the term “radio” frequency is used herein, this term should be understood to include any electromagnetic waves with frequencies below the infrared, i.e. also encompassing microwave frequencies. The processor 1 comprises an RF signal generator 10 configured to generate the plurality of RF signals.

Each RF signal comprises a plurality of RF frequencies with respective component values representing input data. The RF frequencies may be any frequency within the radio or microwave frequency regimes. Typical RF frequencies used for the present method are in the range of 10 KHz to 50 GHz, optionally 1 MHz to 10 GHz. The plurality of RF frequencies is preferably the same for each RF signal to enable interaction between the data encoded in each RF frequency in the processing operations described later. The RF frequencies may be separated from each other by at least 10 KHz, optionally at least 1 MHz. Preferably the RF frequencies are regularly spaced, such that the interval in frequency is the same between each pair of RF frequencies that are adjacent in frequency. Preferably, the RF frequencies are spaced by intervals corresponding to the lowest RF frequency used, such that each RF frequency is an integer multiple of the lowest RF frequency.

Providing S10 the RF signals may comprise generating an initial RF signal comprising each of the plurality of RF frequencies, and modulating each RF frequency of the initial RF signal with input data to generate the plurality of RF signals. This can allow the input data to be provided to the processor in a traditional format, which is then encoded into the RF frequencies by the processor, rather than requiring the input data to be provided in the form of RF signals.

The RF signal generator 10 may comprise a power splitter. After generating the initial RF signal, the power splitter may be used to divide the initial RF signal into a plurality of identical copies of the RF signal, each copy comprising each of the plurality of RF frequencies. Each RF frequency of each copy of the RF signal is then modulated appropriately so that its component value encodes an input value from the input data. This produces the plurality of RF signals, in which the component value of each RF frequency of each RF signal encodes an input value from the input data. For example, the respective component values of the RF frequencies of the plurality of RF signals may represent elements of a plurality of input matrices.

The method further comprises providing S20 a plurality of optical signals. Each optical signal has a respective optical frequency. The optical frequency of each optical signal is different from the optical frequency of every other optical signal to maintain their independence. Suitable optical frequencies include infrared and visible frequencies. Typical optical frequencies used for the present method are in the range of 300 GHz to 30 PHz, optionally 10 THz to 1 PHz, optionally 100 THz to 750 THz, optionally 150 THz to 300 THz, optionally 184.49 THz to 237.93 THz. The processor 1 comprises an optical signal generator 12 configured to generate the plurality of optical signals.

The optical frequencies of the plurality of optical signals are preferably separated from each other by at least two times a highest of the plurality of RF frequencies. This ensures that the modulated optical signals do not interfere with one another and distort the input data encoded in the modulated optical signals. Optionally, the optical frequencies of the plurality of optical signals are separated from each other by at least 10 GHz, optionally at least 20 GHz, optionally at least 50 GHz, optionally at least 100 GHz. Preferably the optical frequencies are regularly spaced, such that the interval in frequency is the same between each pair of optical frequencies that are adjacent in frequency.

The optical and RF signals are discussed in terms of frequencies above. However, they may equally well be defined in terms of their wavelength according to the well-known relationship between wavelength and frequency for electromagnetic waves in free space. Some of the results below discuss the optical and RF signal properties in terms of wavelength.

Providing S20 the plurality of optical signals may comprise demultiplexing a combined optical signal comprising a plurality of optical frequencies into individual optical signals. Each individual optical signal has a respective one of the plurality of optical frequencies of the combined optical signal. This may be helpful where a single light source is used that generates light having a plurality of frequencies simultaneously. For example, the optical signal generator may comprise a broadband light source, such as a frequency comb, supercontinuum laser, or LED bank. The LED bank may be a set of plural LEDs each emitting light of a different wavelength. Once demultiplexed, each individual optical signal provides one of the plurality of optical signals.

The method further comprises modulating S30 each optical signal with a respective RF signal of the plurality of RF signals to generate modulated optical signals. The processor 1 comprises a modulator 14 configured to generate the modulated optical signals. The modulator 14 may comprise any suitable component capable of combining optical and RF signals, such as an electro-optic modulator array. Combining the RF signals and optical signals in this way allows each modulated optical signal to carry multiple input values, thereby permitting the highly parallelised processing mentioned above.

As discussed, one particularly advantageous application of the method is where the component values of the RF frequencies of the RF signals represent elements of a plurality of input matrices. This allows highly parallelised matrix-vector and/or matrix-matrix operations. To demonstrate this, consider the case where the input data is a 3D array X_{3D}

$${X}_{3 D} = [ {X}_{2 D , 1 @ {λ}_{1}} , {X}_{2 D , 2 @ {λ}_{2}} ⋯ {X}_{2 D , Q {λ}_{Q}} ] , {X}_{2 D , q @ {λ}_{q}} = {[ \begin{matrix}{x}_{11} {x}_{12} ⋯ {x}_{1 N} \\ {x}_{21} {x}_{22} ⋯ {x}_{2 N} \\ ⋱ \\ {x}_{M 1} {x}_{M 2} ⋯ {x}_{MN}\end{matrix} ]}_{q}$$

representing multiple d_{M×N} matrices.

To represent this input data, N RF signals and Q optical signals are combined by modulation as described above and applied to M physical input lines to produce Q d_{M×N} matrices. FIG. 5 compares this 3D input scheme to the 1D and 2D input schemes shown in FIG. 1 and FIG. 2.

FIG. 5 demonstrates how the method adds the radio frequency (RF) dimension by using continuous-time data representation, inputting three-dimensional (3D) array to achieve parallel MMM. For a given d_{M×N} matrix, data in the m^{th} row is carried by a continuous-time signal

$${in}_{m} ( t ) = {\sum }_{n = 1}^{N} {x}_{mn} {e}^{i 2 π {f}_{n} t}$$

through encoding individual elements into N different RF component values. All the N elements are input via Channel m (Ch m) in an operation cycle. The weighted sum of M such inputs from M channels will be

$$out ( t ) = {\sum }_{m = 1}^{M} {w}_{m} {in}_{m} ( t ) = {\sum }_{n = 1}^{N} {\sum }_{m = 1}^{M} {w}_{m} {x}_{mn} {e}^{i 2 π {f}_{n} t} ,$$

whose Fourier transform is

$$out ( f ) = {\sum }_{n = 1}^{N} {\sum }_{m = 1}^{M} {w}_{m} {x}_{mn} δ ( f - {f}_{n} ) ,$$

representing the collective results of individual columns embedded in N orthogonal RF components convolved by a 1D weight array wₘ.

The method further comprises performing S40 processing operations on the modulated optical signals in parallel to derive a processor output. The processing operation may be or may comprise a matrix-vector multiplication and/or a matrix-matrix multiplication, such that the processor output represents the results of a plurality of matrix vector multiplications and/or matrix-matrix multiplications performed in parallel.

The processor 1 comprises a processing operation unit 20 configured to perform S40 the processing operation on each modulated signal in parallel to derive the processor output. In the example of FIG. 4, the processing operation unit 20 comprises an optical waveguide crossbar array (also referred to as a photonic crossbar array) having a plurality of input lines 26 and a plurality of output lines 28. The modulator 14 is configured to provide the modulated optical signals to the input lines 26 of the optical waveguide crossbar array.

The processor 1 further comprises an electronic control element 30, for example an application-specific integrated circuit or a field programmable gate array, configured to control the RF signal generator 10 to generate the RF signals and/or to receive the processor output from the processing operation unit 20.

FIG. 6 shows further detail of the data architecture and working principle of the photonic crossbar array for in-memory computing using a continuous-time data representation of the input data with the available three degrees of freedom. The photonic crossbar array system shown in FIG. 6 is based on electro-optically controlled PIC technology and performs ultra-parallel in-memory computing that utilizes the space, optical wavelength, and RF dimension simultaneously. The working principle of processing one d_{M×N} matrix carried by an optical wavelength is described without loss of generality.

The crossbar array has M inputs and K outputs, defining a matrix W of dimension d_{k×M} containing K d_{1×M} kernels is defined by the cross-bar array with M inputs and K outputs. Carried by one modulated optical signal having a wavelength λ₁, a d_{M×N} matrix X is input using M input channels (the M input lines 26 that use the space dimension) and N multiplexed RF components (RF dimension). The n^{th} d_{M×1} vector (x₁ₙ x₂ₙ . . . x_{Mn}) is encoded in the amplitude of the n^{th} RF frequency fₙ. The m^{th} element is input via input waveguide channel m.

The method further comprises multiplexing S35 subsets of the modulated optical signals into multiplexed optical signals before performing S40 the processing operation, and performing the processing operation on the multiplexed optical signals. Consequently, Q parallel d_{k×M}×d_{M×N} MMMs (equivalent to Q×N d_{k×M}×d_{M×1} MVMs in an operation cycle) can be implemented in parallel using Q modulated optical signals having different optical wavelengths (frequencies), where each optical wavelength carries a d_{M×N} matrix.

As shown in FIG. 4, the processing operation unit 20 comprises an array of photonic memory elements, in this example provided as part of cells 24 arranged at crossing points of the optical waveguide crossbar array such that the photonic memory elements are arranged at crossing points of the optical waveguide crossbar array. The crossing points are points at which the input lines 26 cross the output lines 28. Preferably each input line 26 crosses each output line 28. In FIG. 4, the input lines 26 and output lines 28 are arranged in a regular grid in which the input lines 26 and output lines 28 extend in perpendicular directions and are evenly spaced. While convenient, this arrangement is not essential and other arrangements are possible.

Performing S40 the processing operation may comprise inputting the modulated optical signals into the array of photonic memory elements. Each photonic memory element may be configured to store a value of an element of a data matrix. The photonic memory elements may comprise phase change material (PCM) memory to enable in-memory computing. The photonic memory elements may be set in any suitable way depending on their implementation. For example, when a PCM is used, the photonic memory elements may be set using the same optical signal generator 12 as is used for providing the optical signals. Alternatively, the PCM may be set using other elements, such as a heating element associated with each PCM memory element.

This means that the processor 1 of FIG. 4 and FIG. 6 processes the 3D array input using the electro-optically controlled photonic crossbar array with non-volatile PCM memories to enable photonic in-memory computing that minimizes latency and movement of memory data. A respective output signal of each output line 28 represents a dot-product between values stored in the photonic memory elements 24 of a respective column of the optical waveguide crossbar array and the modulated optical signals.

In FIG. 6, each cell 24 in the crossbar array contains a tuneable power splitter for optical power distribution and routing, the photonic memory element (or weight) for multiplication, a waveguide crossing for interconnect, and a directional coupler (DC) for addition (accumulation). Therefore in addition to the photonic memory elements, the processing operation unit 20 further comprises tuneable power splitters and/or directional couplers arranged at the crossing points of the optical waveguide crossbar array. This cell architecture is highly scalable by simply repeating the cell array in a 2D plane.

MVM requires that all the photonic memory elements (also referred to as PCM weights or PCM memory in the context of the embodiment shown in FIG. 6 where the memory elements are implemented using PCM) receive the same input power and also requires that outputs from different cells have the same contribution for linear accumulation. The requirements are fulfilled by meticulous power splitter and DC design.

The equal power distribution is achieved by careful power splitter design. A power splitter is formed by a 1×2 multimode interferometer (MMI), a tunable Mach-Zehnder interferometer (MZI), and a 2×2 MMI in sequence. The input optical power to the k^{th} cell of any row is

$$\frac{K - k + 1}{K} .$$

The MZI determines the 2×2 MMI outputs by controlling the phases of two inputs, and is designed to transmit

$$\frac{K - k + 1}{K} \times \frac{K - k}{K - k + 1} = \frac{K - k}{K}$$

power via the top MMI output to the next cell (k+1)^{th}, and transmit

$$\frac{K - k + 1}{K} \times \frac{1}{K - k + 1} = \frac{1}{K}$$

power via the bottom MMI output to the PCM weight for multiplication. Hence, each PCM weight receives the identical optical power of

$$\frac{1}{K} .$$

The weighted output from PCM weight in row m and column k is

$$\frac{{w}_{mk}}{K} .$$

The DCs are also carefully designed to ensure outputs from different cells provide the same contribution. Since symmetric DCs are used to route weighted outputs from each cell into buses (output lines 28), optical power in buses will partially couple back into cells. The coupling ratio of DCs in row m is designed to be

$$\frac{1}{m} .$$

Consequently, the optical power received at the output waveguide column k from row m is

$$\frac{{w}_{m k}}{K} \times \frac{1}{m} \times ( 1 - \frac{1}{m + 1} ) \times ( 1 - \frac{1}{m + 2} ) \times … \times ( 1 - \frac{1}{K} ) = \frac{{w}_{m k}}{{K}^{2}} ,$$

which is balanced across all cells except for the effect of different weights wₘₖ, i.e. depending on the value stored in the photonic memory elements.

The processing operation is performed using the processing operation unit 20 having a plurality of outputs. Each output is provided to one of the output lines 28. The method further comprises selectively demultiplexing S50 each output of the processing operation unit 20 based on predetermined subsets of optical frequencies. For example, the predetermined subsets may comprise individual ones of the optical frequencies of the original optical signals. The demultiplexing S50 produces a plurality of demultiplexed signals. The method further comprises detecting S60 the resulting demultiplexed signals to derive the processor output. The demultiplexed signals will be output optical signals modulated by output RF signals, the frequencies of the output RF signals encoding the results of the processing operation.

The processor 1 comprises one or more photodetectors 22 configured to detect an output of the processing operation unit 20 to derive the processor output. The processor 1 may comprise one photodetector 22 for each output line 28, or plural photodetectors 22 for each output line. The photodetectors 22 may detect the demultiplexed signals. The predetermined subsets of optical frequencies for the demultiplexing may be determined based on the properties of the photodetectors 22, for example a range of optical frequencies detectable by the photodetectors 22.

Although the specific example discussed above uses a photonic crossbar array in the context of performing MVMs, the method is not limited to a photonic crossbar array nor the calculation of MVMs. The method is in principle viable for any photonic information processing system to enhance its parallelism significantly.

Standalone, off-chip light sources, amplifiers, modulators, and photodetectors are used in the experimental results below that verify the high parallelism. However, these active photonic components can be integrated on a single chip monolithically^{9, 21}. This would facilitate applications of the processor 1 such as for a co-processor in a larger computing system.

### Results

### Verification of Basic Operations Using Continuous-Time Data Representation

The extra RF dimension is introduced using a continuous-time data representation. Therefore, experiments were conducted to first verify the feasibility of using continuous-time data representation for photonic in-memory computing with processor designs such as those illustrated above.

Photonic crossbar arrays provide four fundamental functions: data transmission by waveguides, data weighting by photonic memory elements (such as PCM memory), data summation by routing cell outputs to common buses, and a combination of data weighting and summation. These four functions correspond to four mathematical operations respectively: multiplicative identity (referred to as transmission for terminology simplicity), multiplication, addition, and multiply-accumulate (MAC).

The four basic operations using continuous-time data representation were studied using a waveguide device that represents part of a single cell of the photonic crossbar arrays discussed above. FIG. 7 shows a scanning electron microscope (SEM) image of the waveguide device loaded with PCM memory for multiplication and MAC verification. The inset shows the PCM memory.

The fabrication of the waveguide device started from a silicon-on-insulator wafer (SOI, SOITECH) with 220-nm silicon (Si) device layer and 2-μm buried oxide (BOX) layer. A 400-nm-thick positive ebeam resist (CSAR-62) was spin-coated on a diced 1 cm×1 cm SOI chip, followed by 3 minutes pre-bake at 150°. The ebeam resist was patterned by ebeam lithography (EBL, JEOL JBX-5500 50 kV) and developed in AR600-546 for 30 seconds, MIBK for 15 seconds, and IPA for 15 seconds in sequence. The waveguide patterns were transferred to the Si device layer (etch depth=110 nm) by reactive ion etching (RIE, Oxford Instrument PlasmaPro) with SF₆ and CHF₃ gases, followed by O₂ plasma cleaning of CSAR. Next, a 2-μm-thick double-layer PMMA (PMMA 495 A8 and PMMA 950 A8) was spin-coated on the chip, followed by EBL patterning and development in MIBK:IPA=1:3 for 1 minute to define the sputtering windows. A 10-nm/10-nm-thick Ge₂Sb₂Te₅/ITO stack was deposited on the waveguide using a magnetron sputtering system (PVD, AJA International Inc.). The GST and ITO targets were respectively sputtered at 30 W RF power with 3 sccm Ar flow and 40 W RF power with 3 sccm Ar flow at a base pressure of 10⁻⁷ torr. The stack was then lift-off in acetone for 180 minutes at 50°. Finally, the chip was annealed on a hotplate for 5 minutes at 250° C. to fully crystallize the GST.

The setup used to verify transmission and multiplication was an optical waveguide pump-probe setup shown in FIG. 8, and previously disclosed²². The pump laser line (solid orange lines) is used to set the weight determined by PCM memory. The probe laser line (black solid lines) is used for readout. The full setup was used for multiplication verification. The pump laser line was idle in transmission verification since PCM memory was not involved in this operation.

The pump line and probe line take opposite routes in the waveguide by using two fiber optic circulators (OC, Thorlabs 6015-3-APC) placed right before the input and output grating couplers (GC). The probe laser (Keysight 7711A) is a tunable continuous wave (CW) laser operating at 1570.02 nm. The polarization of probe light was controlled by a polarization controller (PC, Thorlabs FPC032) to maximize the input to an electro-optic modulator (EOM, Lucent 2623N). The EOM was driven via a bias tee (Mini-Circuits ZFBT-4R2GW+) by a function generator (Tektronix AFG3102C) that generated multiplexed RF signals. The polarization of light after the EOM was controlled by another PC to maximize the coupling between input optical fiber and input GC. The light from output GC was filtered by an optical tunable filter (OTF, Santec OTF-320) set to 1570.02 nm before received by a low-noise photodetector (PD, Newport New Focus 2011).

In the operation verification process, the PD output was split by a BNC splitter and sent to a vector signal analyzer (VSA, Hewlett Packard 89410A) and an oscilloscope (TDS7404, Tektronix, Inc.) to monitor the frequency domain and time domain output respectively.

In the PCM weight setting process, the PD output was sent to a computer to monitor optical transmission levels. The pump laser (another Keysight 7711A) was operated at 1571.02 nm. The CW pump light was converted to pulses by an EOM driven by the function generator. An erbium-doped fiber amplifier (EDFA, Amonics AEDFA-CL-23) was used after the EOM to amplify the optical pump pulse so that the pulse has enough energy to amorphize or crystallize the GST on waveguide.

The pump line output was received by a high-speed PD (Newport New Focus 1811) connected to the oscilloscope to monitor phase change dynamics of the PCM photonic memory elements. FIG. 9 shows the switching dynamics of the GST memory element.

Weight setting (setting of the PCM photonic memory element) is performed by controlling the crystalline state of GST using short optical pulses. The PCM is initially at the fully-crystalline state, causing high optical attenuation. A square optical pulse of 50 ns at 6 mW is able to amorphize the PCM by melting and quenching, leading to reduced optical attenuation. A two-step optical pulse with the first 50 ns square pulse at 6 mW followed by the second 150 ns square pulse at 3 mW is able to recrystallize the PCM by melting and baking, lowering the optical transmission to the initial level. Before reaching equilibrium, there are always certain delay ‘dead time’ that determines how quickly the state can be read after sending a programming pulse.

The setup used to verify addition and MAC was a modified optical waveguide pump-probe setup that accommodates the Y-junction of the waveguide shown in FIG. 7. The setup is shown in FIG. 10. The pump line and probe line followed the same route in the waveguide. The pump laser line (solid orange lines) is used to set the weights determined by PCM memories. An optical switch is used to selectively set PCM weight on each arm of the waveguide. The probe laser line (purple, green, and black solid lines) is used for readout. The full setup was used for MAC. The pump laser line was idle in addition.

Unlike the pump-probe setup used to verify transmission and multiplication, the modified setup in FIG. 10 is symmetric. Due to the symmetry, only the right-hand side of the setup will be described.

The setup in FIG. 10 is similar to the setup shown in FIG. 8. Probe laser 2 (Keysight 7711A) worked at 1570.02 nm. The pump laser (Santec, TSL-550) worked at 1571.02 nm. Before entering the right input GC, the pump light and probe light were multiplexed by a 2×1 fiber optic coupler (Thorlabs, PN1550R5A1) with a coupling ratio of 50:50. After exiting from the middle output GC, pump light was filtered by an OTF (Santec OTF-320) so that only probe light was received by a PD (Newport New Focus 2011). VSA and oscilloscope were used to monitor the frequency domain output and time domain output respectively. A computer was used to monitor optical transmission levels. The left side worked in the same manner, except that Probe laser 1 (another Keysight 7711A) worked at 1570.12 nm to avoid interference in waveguide. The pump light was switched between the left probe line and right probe line by an optical switch (OS, Gezhi GZ-12C-1×2-SM) to set either the left PCM weight or right PCM weight.

FIG. 11 shows the time trace of output using the setup shown in FIG. 10 for PCM switching. The PCM on each arm of the Y-junction of the waveguide can be addressed and set independently (0 s-260 s). The overall transmission is the direct sum of transmission from each arm (260-280 s), and the overall transmission change is the direct sum of transmission change caused by each PCM (280 s-330 s).

To test the four basic operations, fifty RF components (N=50) were multiplexed to generate d_{1×50} input vectors. All input numbers x are randomly generated from [0,1]⊆R with 0.01 resolution.

In FIG. 12, the single waveguide is used to verify transmission using the testing setup described in relation to FIG. 8 above. The value of each element in the d_{1×50} vector (x₁ x₂ . . . x₅₀) is encoded in the amplitude of respective RF components. The multiplexed RF modulates an optical carrier to generate a continuous-time input

$$in ( t ) = {\sum }_{j = 1}^{N} {x}_{j} {e}^{i 2 π {f}_{j} t .}$$

FIG. 13 shows a comparison of normalized measured and expected time-domain transmission output and FIG. 14 shows a comparison of normalized measured and expected frequency-domain output. As can be seen, both time-domain output and frequency-domain output are essentially identical to the input. The transmission accuracy is revealed by the error distribution. FIG. 15 shows errors of 300 transmission results. The inset in FIG. 15 shows the normalized error distribution. The errors follow a Gaussian distribution and show a normalized standard deviation (SD) of 0.018±0.001.

In FIG. 16, the Y-junction of the waveguide is used to verify addition using the testing setup described in relation to FIG. 10 above. FIG. 17 and FIG. 18 show comparisons of normalized measured and expected time-domain and frequency-domain outputs respectively. The time-domain output (FIG. 17) is the direct sum of two inputs:

$$Out ( t ) = {\sum }_{j = 1}^{N} {x}_{j} {e}^{i 2 π {f}_{j} t} + {\sum }_{k = 1}^{N} {x}_{k} {e}^{i 2 π {f}_{k} t} ,$$

and the frequency-domain output (FIG. 18) is the sum of amplitudes of two RF components at discrete frequencies: Out(f)=ΣₖΣⱼ(xₖ+xⱼ)δ(fₖ−fⱼ).

The addition accuracy is revealed by the error distributions. FIG. 19 shows errors of 300 addition results. The inset in FIG. 19 shows the normalized error distribution. The errors follow a Gaussian distribution and show a normalized SD of 0.034±0.002.

In system operation, multiple optical wavelengths are used to harness the OWDM parallelism. Thus, the effect of wavelength spacing (Δλ) between two inputs and numbers of multiplexed RF frequencies on operation accuracy was studied.

FIG. 21 shows the accuracy of addition operation when using two different wavelengths with varying wavelength spacing Δλ. At each wavelength spacing, the addition operation is implemented 6 times with a parallelism of N=50 enabled by multiplexing 50 RF frequencies. Measured addition results of 300 pairs of random numbers are shown for each wavelength spacing. All random numbers are in [0,1]=R with a resolution of 0.01. As Δλ decreases from 1 nm to 0.001 nm, the addition error SD stabilizes at 0.035±0.002, indicating the feasibility of using dense OWDM with continuous-time data representation.

FIG. 22 shows accuracy of transmission and FIG. 23 shows accuracy of addition operations when using different numbers of multiplexed RF frequencies. For each number of multiplexed RFs, both operations are implemented 6 times with a parallelism of 50, resulting in 6×50=300 operation results. Measured 300 operation results are shown for each number of multiplexed RFs. All random numbers are in [0,1]⊆R with a resolution of 0.01. In general, the normalised standard deviation (SD) of operation errors increases with the number of multiplexed RF components (as shown in FIG. 20). However, the SD at N=50 is similar to N=75, and the SD is still below 0.05 at N=150, suggesting that N=50 (as used for the further experiments discussed below) is not a limitation of parallelism for low-precision ML models.

In FIG. 24, a PCM-loaded waveguide is used to verify multiplication using the testing setup described in relation to FIG. 8 above. Multiplication results are weighted inputs. A continuous-time input consisting of multiplicands

$$in ( t ) = {\sum }_{j = 1}^{N} {x}_{j} {e}^{i 2 π {f}_{j} t}$$

is encoded in the RF amplitudes. The multiplier w (or weight) is determined by the PCM crystalline state and can be set using optical pump pulses with varying width as discussed above. As shown in FIG. 25, the resultant change in optical transmission

$$Δ T = \frac{{T}_{set} - {T}_{ref}}{{T}_{ref}}$$

can be continuously tuned from 0% to more than 20% by increasing the amorphization pulse width, demonstrating quasi-analog PCM memory weight setting.

The effective weight w is obtained by mapping ΔT to [0,1] via

$$w = \frac{Δ T}{Δ {T}_{max}} .$$

The resultant output from PCM memory is then w×x∈[0,1]. The frequency-domain outputs at different weights were examined to verify that multiplicands encoded in different RF components are operated by the same multiplier. The frequency-domain output results at different weights are shown in FIG. 26A. The zoom-in shown in FIG. 26B suggests qualitatively that all multiplicands encoded in different RF components encounter similar multipliers, undergoing a larger multiplier when PCM is set by longer amorphization pulse. The quantitative results are presented in FIG. 27, which shows calculated AT obtained from the results in FIG. 26A and FIG. 26B. These results show the accurate addressing of different weights by all RF frequencies simultaneously, verifying that the same multiplier is encountered by different RF components (FIG. 27 inset). The multiplication accuracy is revealed by the error distribution of 1500 multiplication results from 300 random multiplicands and 5 multipliers shown in FIG. 28. The errors follow a Gaussian distribution with a SD of 0.056±0.001 as shown in the normalized error distribution of the inset of FIG. 28.

In FIG. 29, a Y-junction loaded with PCM memories on both arms is used to verify MAC using the testing setup described in relation to FIG. 10 above. The input vectors and operation principle are similar to the combination of addition and multiplication. An error SD of 0.057±0.001 is obtained from 1500 MAC results, as shown in FIG. 30. The inset shows the normalized error distribution as for FIG. 28.

The successful verification of the four basic operations proves the feasibility of using continuous-time data representation to add the RF dimension to photonic in-memory computing. Using multiplexed N=50 RF components for a simple PCM-loaded Y-junction, a PEF of 50 is achieved, showing the high parallelism provided by the extra RF dimension.

### Parallel Convolution of 100 ECG Signals

Statistics revealed by the World Health Organization (WHO) show that cardiovascular diseases (CVDs) are the leading cause of death, taking 17.9 million lives, an estimated 32% of all deaths worldwide each year. More than 80% of CVD deaths are caused by sudden heart attacks and strokes. Real-time ECG recording and analysis are crucial to monitor CVD patients' health conditions and minimize sudden death risks. The present computing architecture exploiting three degrees of freedom is a potential platform to perform ultra-parallel convolution of ECG signals, benefiting a large number of CVD patients simultaneously. The convolution results further fed to a CNN could facilitate ML-aided analysis to alert in sudden death events.

Having verified the feasibility of simultaneously using three degrees of freedom, the system depicted in FIG. 6 was used for ultra-parallel convolution of ECG signals. Parallel convolution of 100 ECG signals from CVD patients was performed by the system to demonstrate possible applications for healthcare monitoring.

As discussed above, the processor 1 contains four main parts: an optical signal generator 12 for input light generation and (de) multiplexing, an RF signal generator 10 for input RF generation, a modulator for optical modulation of the optical signals with the RF signals, and a processing operation unit 20 in the form of a photonic crossbar array for in-memory computing. Further parts perform output light (de) multiplexing and detection.

FIG. 31A shows a schematic of the system used for parallel convolution of 100 ECG signals. The photonic crossbar array has 3 input channels and 3 output channels, representing a d_{3×3} matrix consisting of 3 d_{1×3} kernels. The input light is switchable between a supercontinuum laser (SuperK COMPACT, NKT Photonics) and a tuneable pump laser (Santec, TSL-550) using an OS (Gezhi GZ-12C-1×2-SM).

The PCM memory in each cell of the photonic crossbar array was first set to desired weight to correctly define kernels. The tuneable pump laser was used in PCM weight setting. The amplified pump light passed through a DEMUX module (Gezhi, DWDM-100G-DEMUX) so that different optical wavelengths were routed to different input channels (λ₁=1552.52 nm to Ch 1, λ₂=1551.72 nm to Ch 2, λ₃=1550.92 nm). The tuneable power splitters of the photonic crossbar array were controlled by a digital signal processor (DSP, Analog Device DC2026) to ensure that all pump power was concentrated into PCM of the target cell. For example, to set w₂₃, λ₃ was used so that the pump light was routed to Ch 3. Cell₁₃ was controlled to distribute all light into the top channel of its 2×2 MMI, and Cell₂₃ was controlled to distribute all light into the MMI bottom channel to efficiently set w₂₃. In this case, Cell₃₃ is idle.

After setting all PCM weights, parallel convolution was performed using the supercontinuum laser. The DEMUX module was used to separate 6 optical wavelengths with a spacing of 0.8 nm to different channels (λ₁=1552.52 nm, λ₂=1551.72 nm, λ₃=1550.92 nm, λ₄=1550.12 nm, λ₅=1549.32 nm, λ₆=1548.51 nm). The ECG signal data were loaded to each wavelength using a variable optical attenuator (VOA, Thorlabs V1550A). The VOAs were driven by a digital signal processor (DSP, NI USB-6259) that generated 50 multiplexed RF components. λ₁ to λ₃ were carrying three respective time-domain data points of ECG signal 1-50, while λ₄ to λ₆ was carrying the same data of ECG signal 51-100. Polarization of output light from VOA was controlled by a PC (Thorlabs FPC032).

The six optical wavelengths were then grouped by a MUX array (Gezhi, DWDM-100G-MUX) to form 3 inputs to respective input channels of the photonic crossbar array (λ₁ and λ₄ to Ch 1, λ₂ and λ₅ to Ch 2, λ₃ and λ₆ to Ch 3). Convolutions were performed naturally as light propagated through the photonic crossbar array. Each output channel of photonic crossbar array contained all wavelengths λ₁ to λ₆. The six wavelengths were demultiplexed and regrouped by a MUX/DEMUX array to form two groups of multiplexed output. λ₁ to λ₃ formed one group representing the convolution results of three time-domain data points of ECG signal 1-50, λ₄ to λ₆ formed another group representing the same of ECG signal 51-100. The resultant six groups of output light were detected by a PD array (Newport New Focus 2011) and finally read out from the DSP.

FIG. 32 shows an optical microscope image of the photonic crossbar array. The electro-optic response of the photonic crossbar array is shown in FIG. 33 and FIG. 34.

Each cell of the photonic crossbar array has a thermo-optically controlled power splitter for arbitrary power distribution. The resistances of the NiCr thermal phase shifters have a mean value of 275.34Ω with a low SD of 3.21Ω. Despite the initial phase difference across different thermal phase shifters that causes different normalized transmission at 0V, all thermal phase shifters can achieve π phase shift using less than 2.5V.

The Si photonic circuit was fabricated using foundry multi-project wafer (MPW) service provided by CORNERSTONE. The detailed specifications of CORNERSTONE standard waveguide components can be found at: https://cornerstone.sotonfab.co.uk/. The fabricated Si photonic circuit has a 1-μm-thick silicon dioxide (SiO₂) upper cladding. SiO₂ windows were patterned by EBL and opened by hydrogen fluoride (HF) for the following deposition of GST/ITO stack which is similar to the previously described GST/ITO sputtering procedure. Next, NiCr heater patterns were defined by EBL using a double-layer PMMA (PMMA 495-A3 and PMMA 495-A6) as the photoresist. A 200-nm-thick NiCr layer was sputtered followed by PMMA lift-off to form NiCr heaters. Gold pads with 75 nm thickness were fabricated using a similar process as NiCr heater fabrication, but with thermal evaporation (Edwards 306). A 3-5 nm Cr layer is deposited before gold deposition to serve as an adhesion layer. The chip was then annealed on a hotplate for 5 minutes at 250° C. to fully crystallize the GST. Finally, the chip was wire-bonded to a printed circuit board (PCB) for electro-optic control.

Long-time-duration ECG signals (shortest duration=4 hours 15 minutes 10 seconds) from ten CVD patients were taken from Sudden Cardiac Death Holter Database in PhysioNet^{23, 24}. The corresponding clinical information of the ten patients are provided in Table 1. 50 normal pulses and 50 dying pulses were extracted from each patient, leading to a total of 500 normal pulses and 500 dying pulses. Each pulse has a 0.7 s duration. The original ECG signals have a 0.004 s time resolution. ECG pulses were extracted with a time interval of 0.02s (i.e. one out of every five original data), leading to 35 data in the extracted ECG pulses. The 0.02 s time interval was carefully chosen to minimize the extracted dataset while maintaining the key features in original ECG pulses. 80% of pulses were used for training and 20% were used for testing, i.e. a total of 800 pulses for training (400 normal pulses and 400 dying pulses) and 200 pulses for testing (100 normal pulses and 100 dying pulses).

TABLE 1

| | | | | | Underlying |
|---|---|---|---|---|---|
| Subject | | | | | Cardiac |
| Number | Gender | Age | History | Medication | Rhythm |
| 1 | Male | 43 | Unknown | Unknown | Sinus |
| 2 | Unknown | 62 | Coronary | Procan SR; | Sinus with |
| | | | bypass | beta-blocker | intermittent |
| | | | grafting; | | demand |
| | | | history of | | ventricular |
| | | | arrhythmia | | pacing; CPR |
| | | | | | at time of |
| | | | | | cardiac arrest |
| 3 | Male | 34 | Unknown | Unknown | sinus |
| 4 | Female | 89 | Unknown | Unknown | Atrial |
| | | | | | fibrillation |
| 5 | Male | Unknown | Unknown | Unknown | Sinus |
| 6 | Male | 68 | History of | quinidine | Sinus |
| | | | ventricular | digoxin; | |
| | | | ectopy | gluconate | |
| 7 | Female | Unknown | Unknown | Unknown | Sinus |
| 8 | Male | 34 | Unknown | Unknown | Sinus |
| 9 | Male | 80 | Unknown | Unknown | Sinus |
| 10 | Female | 82 | Heart | None listed | Sinus |
| | | | failure | | |

All patients had a sustained ventricular tachyarrhythmia or ventricular fibrillation (VF, a type of abnormal heart rhythm caused by the useless twitch of lower heart chambers), and most had an actual cardiac arrest. These recordings were mainly obtained in the 1980s in Boston area hospitals, and were later compiled as part of a study of VFs. Because of the retrospective nature of this collection, there are important limitations. Patient information is limited, and sometimes completely unavailable, including data regarding drug regimens and drug dosages. Further, these cases may not be representative of spontaneous episodes of sudden death in what is likely a very heterogeneous group of subjects. Despite these shortcomings, these unique recordings may provide important clues to the pathogenesis of sudden death syndrome.

ECG signals which are originally in the form of 1D time-domain arrays are processed by encoding data from patient j at time i (xᵢⱼ) in the amplitude of RF component fⱼ carried by optical wavelength λᵢ. For simplicity, the generation of multiplexed RF signals is described without OWDM. In the case of using OWDM, the method of generating multiplexed RF signals was repeated for each optical wavelength.

Without loss of generality, FIG. 31B shows the data format of the first three data points of 50 ECG signals encoded in 50 different RF components carried by three wavelengths. For parallel convolution of the first three time-domain data points of 50 ECG signals in one operation cycle with j∈[1,50]⊆Z⁺, i∈[1,3]⊆Z⁺, the input matrix is a d_{3×50} matrix:

$$X = [ \begin{matrix}{x}_{11} & {x}_{12} & … & {x}_{1 , 50} \\ {x}_{21} & {x}_{22} & … & {x}_{2 , 50} \\ {x}_{31} & {x}_{32} & … & {x}_{3 , 50}\end{matrix} ]$$

The ECG signals are 1D time-domain signals. As illustrated in FIG. 31B, the j^{th} column of X contains the first three time-domain data points of the j^{th} ECG signal. The i^{th} row of X (carried by λᵢ and sent to Ch i) contains the i^{th} time-domain data of 50 ECG signals. Taking the first row (x₁₁ x₁₂ . . . x_{1,50}) for example, the j^{th} element x₁ⱼ, j∈[1,50]⊆Z⁺ was encoded in the amplitude of RF component fⱼ using λi as the carrier, resulting in a continuous-time data representation x₁ⱼe^{i2πf}^{ⱼ}^{t}. The whole row was represented by the multiplexed RF signal

$$i {n}_{1} ( t ) = {\sum }_{j = 1}^{50} {x}_{1 j} {e}^{i 2 π {f}_{j} t} .$$

### Similarly,

$$i {n}_{2} ( t ) = {\sum }_{k = 1}^{50} {x}_{2 k} {e}^{i 2 π {f}_{k} t} and {in}_{3} ( t ) = {\sum }_{l = 1}^{50} {x}_{3 l} {e}^{i 2 π {f}_{l} t} .$$

The d_{3×3} weight bank determined by the photonic memory elements of the photonic crossbar array defines a d_{3×3} matrix and is set to

$$W = {[ \begin{matrix}{w}_{11} & {w}_{21} & {w}_{31} \\ {w}_{12} & {w}_{22} & {w}_{32} \\ {w}_{13} & {w}_{23} & {w}_{33}\end{matrix} ]}^{T} = {[ \begin{matrix}- 1 & 1 & 1 \\ 1 & - 1 & 1 \\ 1 & 1 & - 1\end{matrix} ]}^{T} ,$$

which contains three d_{1×3} kernels:

$${[ \begin{matrix}- 1 \\ 1 \\ 1\end{matrix} ]}^{T}$$

for left edge detection,

$${[ \begin{matrix}1 \\ - 1 \\ 1\end{matrix} ]}^{T}$$

for peak suppression, and

$${[ \begin{matrix}1 \\ 1 \\ - 1\end{matrix} ]}^{T}$$

for right edge detection.

The three inputs with continuous-time data representation were mathematically generated in MATLAB R2021b, and converted to .TFW files readable by the function generator (Tektronix AFG3102C). The subsequent electrical output from the function generator drove VOAs to load the ECG data into the optical domain. in₁(t) to in₃(t) were input to Ch 1 to Ch 3 respectively. The photonic crossbar array was then effectively performing

$$Y ( t ) = W \cdot X ( t ) = {[ \begin{matrix}{w}_{11} & {w}_{21} & {w}_{31} \\ {w}_{12} & {w}_{22} & {w}_{32} \\ {w}_{13} & {w}_{23} & {w}_{33}\end{matrix} ]}^{T} [ \begin{matrix}{\sum }_{j = 1}^{50} {x}_{1 j} {e}^{i 2 π {f}_{j} t} \\ {\sum }_{k = 1}^{50} {x}_{2 k} {e}^{i 2 π {f}_{k} t} \\ {\sum }_{l = 1}^{50} {x}_{3 l} {e}^{i 2 π {f}_{l} t}\end{matrix} ] = [ \begin{matrix}{\sum }_{j = 1}^{50} {w}_{11} {x}_{1 j} {e}^{i 2 π {f}_{j} t} + {\sum }_{k = 1}^{50} {w}_{21} {x}_{2 k} {e}^{i 2 π {f}_{k} t} + {\sum }_{l = 1}^{50} {w}_{31} {x}_{3 l} {e}^{i 2 π {f}_{l} t} \\ {\sum }_{j = 1}^{50} {w}_{12} {x}_{1 j} {e}^{i 2 π {f}_{j} t} + {\sum }_{k = 1}^{50} {w}_{22} {x}_{2 k} {e}^{i 2 π {f}_{k} t} + {\sum }_{l = 1}^{50} {w}_{32} {x}_{3 l} {e}^{i 2 π {f}_{l} t} \\ {\sum }_{j = 1}^{50} {w}_{13} {x}_{1 j} {e}^{i 2 π {f}_{j} t} + {\sum }_{k = 1}^{50} {w}_{23} {x}_{2 k} {e}^{i 2 π {f}_{k} t} + {\sum }_{l = 1}^{50} {w}_{33} {x}_{3 l} {e}^{i 2 π {f}_{l} t}\end{matrix} ]$$

The frequency-domain representation of Y is:

$$Y ( f ) = [ \begin{matrix}{y}_{11} & {y}_{12} & … & {y}_{1 , 50} \\ {y}_{21} & {y}_{22} & … & {y}_{2 , 50} \\ {y}_{31} & {y}_{32} & … & {y}_{3 , 50}\end{matrix} ] = [ \begin{matrix}{{\sum }^{50}}_{l = 1} & {{\sum }^{50}}_{k = 1} {\sum }_{j = 1}^{50} ( {w}_{11} {x}_{1 j} + {w}_{21} {x}_{2 k} + {w}_{31} {x}_{3 l} ) \times δ ( {f}_{j} - {f}_{k} ) ( {f}_{k} - {f}_{l} ) \\ {\sum }_{l = 1}^{50} & {\sum }_{k = 1}^{50} {\sum }_{j = 1}^{50} ( {w}_{12} {x}_{1 j} + {w}_{22} {x}_{2 k} + {w}_{32} {x}_{3 l} ) \times δ ( {f}_{j} - {f}_{k} ) ( {f}_{k} - {f}_{l} ) \\ {\sum }_{l = 1}^{50} & {\sum }_{k = 1}^{50} {\sum }_{j = 1}^{50} ( {w}_{13} {x}_{1 j} + {w}_{23} {x}_{2 k} + {w}_{33} {x}_{3 l} ) \times δ ( {f}_{j} - {f}_{k} ) ( {f}_{k} - {f}_{l} )\end{matrix} ]$$

where yᵢⱼ=w₁ᵢx₁ⱼ+w₂ᵢx₂ⱼ+w₃ᵢx₃ⱼ was encoded in RF component fⱼ, representing the convolution result of the first three time-domain data of the j^{th} ECG signal using the i^{th} kernel. Each row of Y was output from the respective photonic crossbar array output channel.

In an operation cycle, the system is effectively performing 150 convolutions in parallel with results in a d_{3×50} matrix Y, convolving the first three data of 50 ECG signals using three kernels. With an additional three optical wavelengths λ₄, λ₅, λ₆ to bring OWDM parallelism into the system as shown in FIG. 31A, the number of wavelengths is doubled to perform parallel matrix-matrix multiplication. The system is then effectively performing convolution on 50×2=100 ECG signals in parallel in an operation cycle. For visual clarity, only one matrix-matrix multiplication is illustrated in FIG. 31B without loss of generality.

The convolution results are further fed to a convolutional neural network (CNN) for machine-learning (ML) aided ECG signal analysis. The CNN architecture is illustrated with a single ECG signal without loss of generality in FIG. 35.

The CNN is designed to classify CVD patients' identities and alert in sudden death events caused by VF. The input layer takes the ECG pulse, which is in the form of a d_{35×1 1}D array. The 1D array is passed to a convolution layer consisting of three d_{1×3} kernels. Convolution operations were implemented with a stride of 1 and valid padding, resulting in a d_{3×(35-3+1)} output. The output was activated by a Rectified Linear Unit (ReLu) layer and flattened to a d_{99×1} vector. The flattened activated output was then fed to a fully-connected layer with 20 neurons. The output from the fully-connected layer was converted to probabilities by a Softmax layer. Finally, the classification result was obtained. The ECG pulses were classified into 20 categories, representing two heart health conditions (normal or dying) of 10 individual patients.

The convolution operations were implemented using the electro-optically controlled photonic crossbar array system as described above and shown in FIG. 31. The convolution results were processed by the following CNN layers using MATLAB R2021b Deep Leaning toolbox. Weights of the fully connected layer were trained by Adam optimizer. 100 epochs were used to reach final CNN outcomes.

Typical convolution results of normal and risky ECG signals are presented. FIG. 36 shows the expected convolution results (convolved by CPU) and FIG. 37 shows the measured convolution results (convolved by photonic processor system) of normal ECG signals when patients are safe. FIG. 38 and FIG. 39 show the corresponding convolution results in sudden death events when patients are in danger experiencing ventricular fibrillation. All other convolution results are shown in FIG. 40 and FIG. 41. FIG. 40 shows convolution results of CVD patients 1 to 5, and FIG. 41 shows convolution results of CVD patients 6 to 10.

The results show that the features are extracted effectively, and the measured results resemble the expected ones. The system convolution accuracy is examined by comparing CPU-convolved and system-convolved results as shown in FIG. 42. The inset shows the normalized error distribution. The errors follow a Gaussian distribution with a low SD of 0.015±0.001. The SD is lower than that obtained in MAC verification because most convolution results are small in the range of [0,0.5]⊆R.

The CNN classification accuracies are presented in FIG. 43. In the absence of a convolution layer, only 89% accuracy can be reached. With a convolution layer that helps to extract features, the accuracy is increased to 94% and 93.5% when CPU-convolved and system-convolved results respectively are used. The confusion maps of classification results using CPU-convolved and system-convolved results are shown in FIG. 44 and FIG. 45 respectively. Importantly, there is only 1% probability that a risky ECG signal will be misclassified as normal ECG signal. Similar details are observed in the two maps, indicating the simultaneous achievement of high accuracy, effectiveness, and ultra-parallelism using our system that exploits three degrees of freedom.

Minor differences in loss and accuracy evolution curves with increasing epoch are observed between using CPU-convolved and system-convolved results as shown in FIG. 46 and FIG. 47, suggesting a high accuracy of system-implemented MMM using continuous-time data representation.

The present system and method provides a photonic in-memory computing architecture capable of implementing parallel MMMs in one operation cycle of a physical device. This contrasts to previous efforts which cannot yet achieve parallel MVMs (i.e. one MMM) in one operation cycle. The feasibility of computing with continuous-time data in the optical domain was verified, proving the possibility of adding an RF degree of freedom to photonic processors.

An electro-optically controlled photonic crossbar array system built upon this principle can simultaneously exploit space, optical wavelength, and RF dimensions to harness ultra-parallelism. The results demonstrate that the present method achieves a PEF of 100, two orders higher than the previous photonic crossbar array system by multiplexing 50 RF components on top of 2 optical wavelengths. The demonstrated PEF of 100 is not the limit. As indicated in FIG. 22 and FIG. 23, multiplexing 150 RF components is possible if lower precision is allowed. Use of a greater number of optical wavelengths is also possible. For example, 16 optical wavelengths would achieve an overall PEF of 2400.

Leveraging the high PEF, an illustrative application was demonstrated, performing ultra-parallel convolution of 100 ECG signals from CVD patients. A CNN for healthcare monitoring built on the system-processed convolution results can recognize patients' identity and alert in sudden death events with 93.5% accuracy.

A key understanding underlying the mechanism of ultra-parallel data processing is that while wavelength spacing (0.8 nm) is called ‘dense’ in OWDM, it is a huge bandwidth from the RF perspective. Therefore, the RF dimension can be regarded as a quasi-independent dimension that enriches data information. Meanwhile, continuous-time data representation brings another key advantage of avoiding electronic logic state flips to potentially increase clock frequency.

### REFERENCES

1. Zhou, H. et al. Photonic matrix multiplication lights up photonic accelerator and beyond. Light Sci. Appl. 11, 30 (2022).
2. Wetzstein, G. et al. Inference in artificial intelligence with deep optics and photonics. Nature 588, 39-47 (2020).
3. von Bieren, K. Lens Design for Optical Fourier Transform Systems. Appl. Opt. 10, 2739-2742 (1971).
4. Optical matrix-matrix multiplier based on outer product decomposition. Neuroendocrinology 34, 309-309 (1982).
5. Yan, T. et al. All-optical graph representation learning using integrated diffractive photonic computing units. Sci. Adv. 8, eabn7630 (2022).
6. Li, J., Hung, Y. C., Kulce, O., Mengu, D. & Ozcan, A. Polarization multiplexed diffractive computing: all-optical implementation of a group of linear transformations through a polarization-encoded diffractive network. Light Sci. Appl. 11, 153 (2022).
7. Shastri, B. J. et al. Photonics for artificial intelligence and neuromorphic computing. Nat. Photonics 15, 102-114 (2021).
8. Ashtiani, F., Geers, A. J. & Aflatouni, F. An on-chip photonic deep neural network for image classification. Nature 606, 501-506 (2022).
9. Shu, H. et al. Microcomb-driven silicon photonic systems. Nature 605, 457-463 (2022).
10. Tran, M. A. et al. Extending the spectrum of fully integrated photonics to submicrometre wavelengths. Nature 610, 54-60 (2022).
11. Shen, Y. et al. Deep learning with coherent nanophotonic circuits. Nat. Photonics 11, 441-446 (2017).
12. Mourgias-Alexandris, G. et al. Noise-resilient and high-speed deep learning with coherent silicon photonics. Nat. Commun. 13, 5572 (2022).
13. Tait, A. N., Nahmias, M. A., Shastri, B. J. & Prucnal, P. R. Broadcast and weight: An integrated network for scalable photonic spike processing. J. Light. Technol. 32, 4029-4041 (2014).
14. Huang, C. et al. A silicon photonic-electronic neural network for fibre nonlinearity compensation. Nat. Electron. 4, 837-844 (2021).
15. Xu, X. et al. 11 TOPS photonic convolutional accelerator for optical neural networks. Nature 589, 44-51 (2021).
16. Feldmann, J. et al. Parallel convolutional processing using an integrated photonic tensor core. Nature 589, 52-58 (2021).
17. Rios, C. et al. Integrated all-photonic non-volatile multi-level memory. Nat. Photonics 9, 725-732 (2015).
18. Li, X. et al. Fast and reliable storage using a 5 bit, nonvolatile photonic memory cell. Optica 6, 1-6 (2019).
19. Sludds, A. et al. Delocalized Photonic Deep Learning on the Internet's Edge. Science (80-.). 378, 270-276 (2022).
20. Wang, C. et al. Scalable massively parallel computing using continuous-time data representation in nanoscale crossbar array. Nat. Nanotechnol. 16, 1079-1085 (2021).
21. Liu, Y. et al. A photonic integrated circuit-based erbium-doped amplifier. Science (80-.). 1313, 1309-1313 (2022).
22. Ríos, C. et al. In-memory computing on a photonic platform. Sci. Adv. 5, eaau5759 (2019).
23. Greenwald, S. D. The Development and Analysis of a Ventricular Fibrillation Detector. (Massachusetts Institute of Technology, 1986).
24. Goldberger, A. L. et al. PhysioBank, PhysioToolkit, and PhysioNet: Components of a new research resource for complex physiologic signals. Circulation 101, e215-e220 (2000).

1. A method of processing input data in a processor, the method comprising:
providing a plurality of radio frequency, RF, signals, each RF signal comprising a plurality of RF frequencies with respective component values representing input data;
providing a plurality of optical signals, each optical signal having a respective optical frequency;
modulating each optical signal with a respective RF signal of the plurality of RF signals to generate modulated optical signals; and
performing processing operations on the modulated optical signals in parallel to derive a processor output.

2. The method of claim 1, wherein the optical frequencies of the plurality of optical signals are separated from each other by at least two times a highest of the plurality of RF frequencies, optionally at least 10 GHz.

3. The method of claim 1, wherein providing the plurality of optical signals comprises demultiplexing a combined optical signal comprising a plurality of optical frequencies into individual optical signals, each individual optical signal having a respective one of the plurality of optical frequencies of the combined optical signal.

4. The method of claim 3, wherein the combined optical signal is provided by a broadband light source, a frequency comb, supercontinuum laser, or LED bank.

5. The method of claim 1, wherein providing the RF signals comprises generating an initial RF signal comprising each of the plurality of RF frequencies, and modulating each RF frequency of the initial RF signal with input data to generate the plurality of RF signals.

6. The method of claim 1, further comprising multiplexing subsets of the modulated optical signals into multiplexed optical signals before performing the processing operation, and performing the processing operation on the multiplexed optical signals.

7. The method of claim 1, wherein the processing operation is performed with a processing operation unit having a plurality of outputs, and wherein the method further comprises:
selectively demultiplexing each output of the processing operation unit based on predetermined subsets of optical frequencies and detecting the resulting demultiplexed signals to derive the processor output.

8. The method of claim 1, wherein the processing operation is or comprises a matrix-vector multiplication and/or a matrix-matrix multiplication.

9. The method of claim 8, wherein the respective component values of the RF frequencies of the plurality of RF signals represent elements of a plurality of input matrices.

10. The method of claim 8, wherein performing the processing operation comprises inputting the modulated optical signals into an array of photonic memory elements, each photonic memory element configured to store a value of an element of a data matrix.

11. A processor for processing input data, the processor comprising:
an RF signal generator configured to generate a plurality of RF signals, each RF signal comprising a plurality of RF frequencies with respective component values representing input data;
an optical signal generator configured to generate a plurality of optical signals, each optical signal having a respective optical frequency;
a modulator configured to modulate each optical signal with a respective RF signal of the plurality of RF signals to generate modulated optical signals; and
a processing operation unit configured to perform a processing operation on each modulated signal in parallel to derive a processor output.

12. The processor of claim 11, wherein the optical signal generator is configured to generate optical signals with frequencies separated from each other by at least two times a highest of the plurality of RF frequencies, optionally at least 10 GHz.

13. The processor of claim 11, wherein the optical signal generator comprises a broadband light source, a frequency comb, supercontinuum laser, or LED bank.

14. The processor of claim 11, wherein the modulator comprises an electro-optic modulator array.

15. The processor of claim 11, wherein the processing operation unit is configured to perform matrix vector multiplications and/or matrix-matrix multiplications, such that the processor output represents the results of a plurality of matrix vector multiplications and/or matrix-matrix multiplications performed in parallel.

16. The processor of claim 11, wherein the processing operation unit comprises an optical waveguide crossbar array having a plurality of input lines and a plurality of output lines, wherein the modulator is configured to provide the modulated optical signals to the input lines of the optical waveguide crossbar array.

17. The processor of claim 11, wherein the processing operation unit comprises an array of photonic memory elements, optionally wherein the photonic memory elements comprise phase-change material.

18. The processor of claim 17, wherein:
the processing operation unit comprises an optical waveguide crossbar array having a plurality of input lines and a plurality of output lines;
the modulator is configured to provide the modulated optical signals to the input lines of the optical waveguide crossbar array;
the photonic memory elements are arranged at crossing points of the optical waveguide crossbar array; and
a respective output signal of each output line represents a dot-product between values stored in the photonic memory elements of a respective column of the optical waveguide crossbar array and the modulated optical signals.

19. The processor of claim 17, wherein the processing operation unit further comprises tuneable power splitters and/or directional couplers arranged at the crossing points of the optical waveguide crossbar array.

20. The processor of claim 11, further comprising one or more photodetectors configured to detect an output of the processing operation unit to derive the processor output.

21. The processor of claim 11, further comprising an electronic control element, an application-specific integrated circuit or a field programmable gate array, configured to control the RF signal generator to generate the RF signals and/or to receive the processor output from the processing operation unit.

22. The processor of claim 11, wherein the processor is a co-processor.
